(19) United States
(12) Patent Application Publication
(10) Pub. No.: US 2021/0111752 A1
(43) Pub. Date: Apr. 15, 2021

(54) BASE STATION, TERMINAL APPARATUS, METHOD, PROGRAM, AND NON-TRANSITORY COMPUTER READABLE RECORDING MEDIUM

(71) Applicant: NEC CORPORATION, Tokyo (JP)

(72) Inventors: Yi JIANG, Tokyo (JP); Yasushi MARUTA, Tokyo (JP); Hisashi FUTAKI, Tokyo (JP)

(73) Assignee: NEC Corporation, Tokyo (JP)

(21) Appl. No.: 16/981,107

(22) PCT Filed: Feb. 6, 2019
(86) PCT No.: PCT/JP2019/004167

§ 371 Date: Sep. 15, 2020

(30) Foreign Application Priority Data
Mar. 22, 2018 (JP) 2018-054651

(51) Int. Cl. H04B 1/7143; H04W 72/04

(52) U.S. Cl. CPC H04B 1/7143; H04W 72/0446

(57) ABSTRACT

In order to improve communication in a radio access network, a first base station according to an aspect of the present invention includes: an information obtaining unit configured to obtain hopping pattern control information related to a pattern of frequency hopping for a terminal apparatus; and a first communication processing unit configured to transmit the hopping pattern control information to a second base station.

### BACKGROUND

### Technical Field

The present invention relates to a base station, a terminal apparatus, a method, a program, and a non-transitory computer readable recording medium.

### Background Art

In Long Term Evolution (LTE), frequency hopping is employed to obtain frequency diversity.

For example, as described in NPL 1, physical uplink shared channel (PUSCH) frequency hopping is performed as uplink frequency hopping. The PUSCH frequency hopping is intra-subframe frequency hopping. Specifically, a frequency resource used by user equipment (UE) in a second slot in a subframe is different from a frequency resource used by the UE in a first slot in the subframe. In addition, the PUSCH frequency hopping includes Type-1 hopping and Type-2 hopping. In Type-1 hopping, for example, the frequency offset between the frequency resource used in a first slot and the frequency resource used in a second slot is ¼, −¼, or ½ of a PUSCH frequency region. In other words, Type-1 hopping includes three frequency hopping patterns.

### CITATION LIST

### Non Patent Literature

[NPL 1] 3GPP TS 36.213 V15.0.0, (2017-12) 3rd Generation Partnership Project; Technical Specification Group Radio Access Network; Evolved Universal Terrestrial Radio Access (E-UTRA); Physical layer procedures (Release 15)

### SUMMARY

### Technical Problem

However, evolved Node B (eNB) does not know which frequency hopping patterns (e.g., which ones of the patterns of PUSCH frequency hopping in NPL 1) other eNBs (e.g., neighbor eNBs) use for UEs. For this reason, for example, radio resources and a frequency hopping pattern allocated to a first UE by a first eNB may be the same as radio resources allocated to and a frequency hopping pattern assigned to a second UE by a second eNB. In such a case, even when frequency hopping is performed, interference by the second UE in the first eNB may continue over the entire period of the allocated radio resources. Especially in a case of employing semi-persistent scheduling (SPS), the interference may continue over a long period. This may consequently deteriorate communication quality in a radio access network (RAN).

An example object of the present invention is to provide a base station, a terminal apparatus, and a method that can improve communication in a radio access network.

### Solution to Problem

A first base station according to one aspect of the present invention includes an information obtaining unit configured to obtain hopping pattern control information related to a pattern of frequency hopping for a terminal apparatus, and a first communication processing unit configured to transmit the hopping pattern control information to a second base station.

A second base station according to one aspect of the present invention includes a first communication processing unit configured to receive, from a first base station, hopping pattern control information related to a pattern of frequency hopping for a terminal apparatus, and a second communication processing unit configured to communicate with the terminal apparatus based on the hopping pattern control information.

A terminal apparatus according to one aspect of the present invention includes a communication processing unit configured to communicate with a first base station or a second base station in accordance with a pattern of frequency hopping for the terminal apparatus, wherein the first base station is a base station that transmits, to the second base station, hopping pattern control information related to the pattern of the frequency hopping.

A method in a first base station according to one aspect of the present invention includes obtaining hopping pattern control information related to a pattern of frequency hopping for a terminal apparatus, and transmitting the hopping pattern control information to a second base station.

A program according to one aspect of the present invention causes, in a first base station, a processor to execute obtaining hopping pattern control information related to a pattern of frequency hopping for a terminal apparatus, and transmitting the hopping pattern control information to a second base station.

A non-transitory computer readable recording medium according to one aspect of the present invention has recorded thereon a program that causes, in a first base station, a processor to execute obtaining hopping pattern control information related to a pattern of frequency hopping for a terminal apparatus, and transmitting the hopping pattern control information to a second base station.

A method in a second base station according to one aspect of the present invention includes receiving, from a first base station, hopping pattern control information related to a pattern of frequency hopping for a terminal apparatus, and communicating with the terminal apparatus based on the hopping pattern control information.

A program according to one aspect of the present invention causes, in a second base station, a processor to execute receiving, from a first base station, hopping pattern control information related to a pattern of frequency hopping for a terminal apparatus, and communicating with the terminal apparatus based on the hopping pattern control information.

A non-transitory computer readable recording medium according to one aspect of the present invention has recorded thereon a program that causes, in a second base station, a processor to execute receiving, from a first base station, hopping pattern control information related to a pattern of frequency hopping for a terminal apparatus, and communicating with the terminal apparatus based on the hopping pattern control information.

A method in a terminal apparatus according to one aspect of the present invention includes communicating with a first base station or a second base station in accordance with a pattern of frequency hopping for the terminal apparatus, wherein the first base station is a base station that transmits, to the second base station, hopping pattern control information related to the pattern of the frequency hopping.

A program according to one aspect of the present invention causes, in a terminal apparatus, a processor to execute communicating with a first base station or a second base station in accordance with a pattern of frequency hopping for the terminal apparatus, wherein the first base station is a base station that transmits, to the second base station, hopping pattern control information related to the pattern of the frequency hopping.

A non-transitory computer readable recording medium according to one aspect of the present invention has recorded thereon a program that causes, in a terminal apparatus, a processor to execute communicating with a first base station or a second base station in accordance with a pattern of frequency hopping for the terminal apparatus, wherein the first base station is a base station that transmits, to the second base station, hopping pattern control information related to the pattern of the frequency hopping.

### Advantageous Effects of Invention

According to the present invention, it is possible to improve communication in a radio access network. Note that, according to the present invention, instead of or together with the above effects, other effects may be exerted.

### BRIEF DESCRIPTION OF THE DRAWINGS

FIG. 1 is an explanatory diagram illustrating an example of a schematic configuration of a system according to a first example embodiment;

FIG. 2 is an explanatory diagram for illustrating an example of allocation of uplink radio resources (PUSCH resources) to a terminal apparatus by a base station;

FIG. 3 is an explanatory diagram for illustrating an example of uplink interference;

FIG. 4 is a block diagram illustrating an example of a schematic configuration of a first base station according to the first example embodiment;

FIG. 5 is a block diagram illustrating an example of a schematic configuration of a second base station according to the first example embodiment;

FIG. 6 is a block diagram illustrating an example of a schematic configuration of a third base station according to the first example embodiment;

FIG. 7 is a block diagram illustrating an example of a schematic configuration of a terminal apparatus according to the first example embodiment;

FIG. 8 is an explanatory diagram for illustrating an example of a frequency hopping pattern and measurement of a received power in the first example embodiment;

FIG. 9 is an explanatory diagram for illustrating an example of a frequency hopping pattern and measurement of interference in the first example embodiment;

FIG. 10 is a sequence diagram for illustrating an example of a schematic flow of processing according to the first example embodiment;

FIG. 11 is an explanatory diagram illustrating an example of a schematic configuration of a system according to a second example embodiment;

FIG. 12 is a block diagram illustrating an example of a schematic configuration of a first base station according to the second example embodiment;

FIG. 13 is a block diagram illustrating an example of a schematic configuration of a second base station according to the second example embodiment;

FIG. 14 is a block diagram illustrating an example of a schematic configuration of a terminal apparatus according to the second example embodiment;

FIG. 15 is an explanatory diagram illustrating an example of a schematic configuration of a system according to a third example embodiment;

FIG. 16 is a block diagram illustrating an example of a schematic configuration of a first unit according to the third example embodiment;

FIG. 17 is a block diagram illustrating an example of a schematic configuration of a second unit according to the third example embodiment;

FIG. 18 is a block diagram illustrating an example of a schematic configuration of a terminal apparatus according to the third example embodiment;

FIG. 19 is an explanatory diagram for illustrating an example of a frequency hopping pattern and measurement of a received power in the third example embodiment; and

FIG. 20 is an explanatory diagram for illustrating an example of a frequency hopping pattern and measurement of interference in the third example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. First Example Embodiment
1.1. Configuration of System
1.2. Configuration of Each Node
   1.2.1. Configuration of Base Station 100
   1.2.2. Configuration of Base Station 200
   1.2.3. Configuration of Base Station 300
   1.2.4. Configuration of Terminal Apparatus 400
1.3. Technical Features
1.4. Example Alterations

2. Second Example Embodiment
2.1. Configuration of System
2.2. Configuration of Each Node
   2.2.1. Configuration of Base Station 600
   2.2.2. Configuration of Base Station 700
   2.2.3. Configuration of Terminal Apparatus 800
2.3. Technical Features

3. Third Example Embodiment
3.1. Configuration of System
3.2. Configuration of Each Node
   3.2.1. Configuration of First Unit 1100
   3.2.2. Configuration of Second Unit 1200
   3.2.3. Configuration of Terminal Apparatus 1300
3.3. Technical Features

### 1. First Example Embodiment

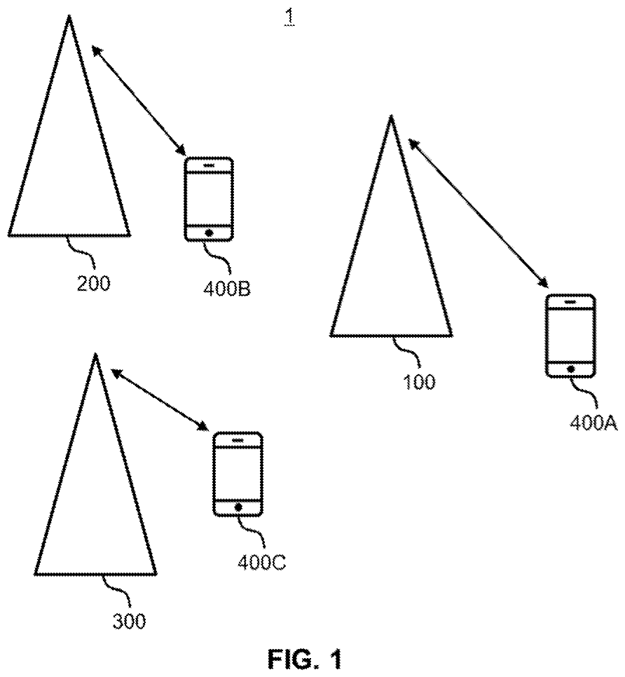

A description will be given of a first example embodiment with reference to FIGS. 1 to 10.

<<1.1. Configuration of System>>

With reference to FIGS. 1 to 3, an example of a configuration of a system 1 according to the first example embodiment will be described.

FIG. 1 is an explanatory diagram illustrating an example of a schematic configuration of the system 1 according to the first example embodiment. With reference to FIG. 1, the system 1 includes a base station 100, a base station 200, a base station 300, and terminal apparatuses 400. Although three terminal apparatuses 400 (i.e., a terminal apparatus 400A, a terminal apparatus 400B, and a terminal apparatus 400C) are illustrated in FIG. 1, the system 1 may include four or more terminal apparatuses 400 or may include only one or two terminal apparatuses 400.

The system 1 is, for example, a system conforming to Third Generation Partnership Project (3GPP) standards/specifications. More specifically, for example, the system 1 may be a system conforming to LTE/LTE-Advanced standards/specifications. Alternatively, the system 1 may be a system conforming to fifth-generation (5G)/New Radio (NR) standards/specifications. The system 1 is, of course, not limited to these examples.

(1) Base Station 100, Base Station 200, and Base Station 300

The base station 100 is a radio access network (RAN) node and is configured to perform radio communication with a terminal apparatus(es) (e.g., the terminal apparatus 400) located in the coverage area of the base station 100.

For example, the base station 100 may be an evolved Node B (eNB) or a gNB in 5G NR. The base station 100 may include a plurality of units (or a plurality of nodes). The plurality of units (or the plurality of nodes) may include a first unit (or a first node) configured to perform higher protocol layer processing and a second unit (or a second node) configured to perform lower protocol layer processing. As an example, the first unit may be referred to as a center/central unit (CU), and the second unit may be referred to as a distributed unit (DU) or an access unit (AU). As another example, the first unit may be referred to as a digital unit (DU), and the second unit may be referred to as a radio unit (RU) or a remote unit (RU). The digital unit (DU) may be a base band unit (BBU), and the RU may be a remote radio head (RRH) or a remote radio unit (RRU). The terms for the first unit (or the first node) and the second unit (or the second node) are, of course, not limited to these examples. Alternatively, the base station 100 may be a single unit (or a single node). In this case, the base station 100 may be one of the plurality of units (e.g., either one of the first unit and the second unit) or may be connected to another unit of the plurality of units (e.g., the other one of the first unit and the second unit).

Descriptions of the base station 200 and the base station 300 are similar to that of the base station 100. Hence, overlapping descriptions are omitted here.

Note that each of the base station 200 and the base station 300 may be a base station of the same type as that of the base station 100 or may be a base station of a different type from that of the base station 100. For example, the base station 100 may be an eNB while the base station 200 (or the base station 300) may also be an eNB, or the base station 100 may be a gNB while the base station 200 (or the base station 300) may also be a gNB. Alternatively, the base station 100 may be one of an eNB and a gNB while the base station 200 (or the base station 300) may be the other one of an eNB and a gNB. Note that, of course, the base station 300 may be a base station of the same type as that of the base station 200 or may be a base station of a different type from the base station 200.

Each of the base station 100, the base station 200, and the base station 300 may be the second unit and may be connected to the same first unit.

(2) Terminal Apparatus 400

Each terminal apparatus 400 (wirelessly) communicates with a base station. For example, the terminal apparatus 400 communicates with the base station in a case of being located in the coverage area of the base station.

For example, as illustrated in FIG. 1, the terminal apparatus 400A is connected to the base station 100 to communicate with the base station 100, the terminal apparatus 400B is connected to the base station 200 to communicate with the base station 200, and the terminal apparatus 400C is connected to the base station 300 to communicate with the base station 300.

For example, each terminal apparatus 400 is a UE.

(3) Interference

For example, the base station 100, the base station 200, and the base station 300 allocates the same radio resources (the same time-frequency resources) to the terminal apparatus 400A, the terminal apparatus 400B, and the terminal apparatus 400C, respectively. In this case, interference may occur.

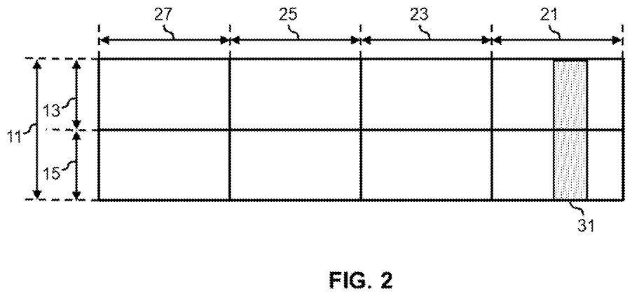

FIG. 2 is an explanatory diagram for illustrating an example of allocation of uplink radio resources (PUSCH resources) to a terminal apparatus by a base station. With reference to FIG. 2, time-frequency resources in a subframe 11 are illustrated. The subframe 11 includes a first slot 13 and a second slot 15. The subframe 11 further includes subbands 21, 23, 25, and 27 in the frequency direction. For example, the base station 100, the base station 200, and the base station 300 allocate a radio resource 31 to the terminal apparatus 400A, the terminal apparatus 400B, and the terminal apparatus 400C, respectively. The radio resource 31 is located at part of the subband 21 in the frequency direction and over the subband 21 in the time direction.

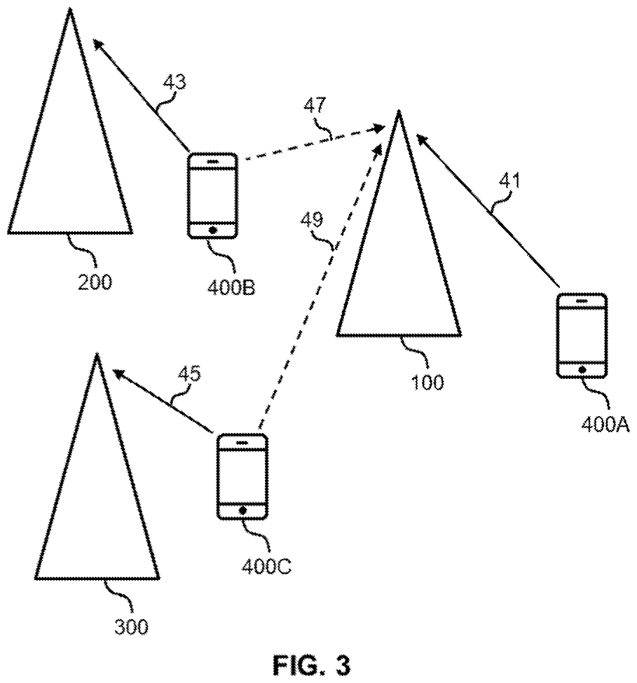

FIG. 3 is an explanatory diagram for illustrating an example of uplink interference. With reference to FIG. 3, the terminal apparatus 400A transmits a signal 41 to the base station 100, the terminal apparatus 400B transmits a signal 43 to the base station 200, and the terminal apparatus 400C transmits a signal 45 to the base station 200. The signal 41, the signal 43, and the signal 45 are desired signals for the base station 100, the base station 200, and the base station 300, respectively. However, for example, the terminal apparatus 400B is located near the boundary between the coverage of the base station 200 and the coverage of the base station 100, and hence a signal 47 (the same signal as the signal 43) from the terminal apparatus 400B reaches the base station 100. This signal 47 may be an interference signal for the base station 100. For example, the terminal apparatus 400C is located near the boundary between the coverage of the base station 300 and the coverage of the base station 100, and hence a signal 49 (the same signal as the signal 45) from the terminal apparatus 400C reaches the base station 100. This signal 49 may be an interference signal for the base station 100.

Especially in a case that SPS is employed for the terminal apparatus 400A, the terminal apparatus 400B, and the terminal apparatus 400C, this interference may continue over a long period.

In the first example embodiment, for example, the terminal apparatus 400A, the terminal apparatus 400B, and the terminal apparatus 400C employ frequency hopping. When a pattern of frequency hopping for the terminal apparatus 400A is the same as patterns of frequency hopping for the terminal apparatus 400B and the terminal apparatus 400C, the interference in the base station 100 is not reduced. In contrast, when the pattern of frequency hopping for the terminal apparatus 400A is different from the patterns of frequency hopping for the terminal apparatus 400B and the terminal apparatus 400C, the interference in the base station 100 may be reduced.

<<1.2. Configuration of Each Node>>

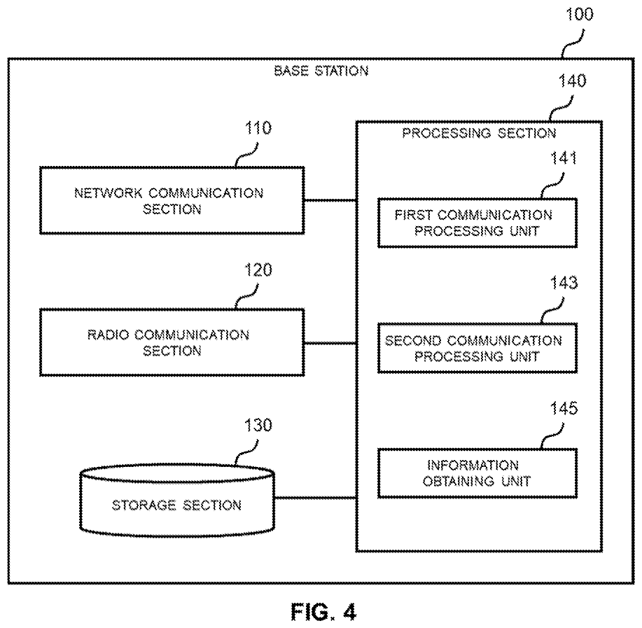

A configuration of each node according to the first example embodiment will be described with reference to FIGS. 4 to 7.

<1.2.1. Configuration of Base Station 100>

FIG. 4 is a block diagram illustrating an example of a schematic configuration of the base station 100 according to the first example embodiment. With reference to FIG. 4, the base station 100 includes a network communication section 110, a radio communication section 120, a storage section 130, and a processing section 140.

(1) Network Communication Section 110

The network communication section 110 receives a signal from a network and transmits a signal to the network.

(2) Radio Communication Section 120

The radio communication section 120 wirelessly transmits and/or receives a signal. For example, the radio communication section 120 receives a signal from a terminal apparatus and transmits a signal to the terminal apparatus.

(3) Storage Section 130

The storage section 130 temporarily or permanently stores programs (instructions) and parameters for operations of the base station 100 as well as various data. The program includes one or more instructions for operations of the base station 100.

(4) Processing Section 140

The processing section 140 provides various functions of the base station 100. The processing section 140 includes a first communication processing unit 141, a second communication processing unit 143, and an information obtaining unit 145. Note that the processing section 140 may further include constituent elements other than these constituent elements. In other words, the processing section 140 may also perform operations other than the operations of these constituent elements. Concrete operations of the first communication processing unit 141, the second communication processing unit 143, and the information obtaining unit 145 will be described later in detail.

For example, the processing section 140 (the first communication processing unit 141) communicates with a different network node (e.g., the base station 200 or the base station 300) via the network communication section 110. For example, the processing section 140 (the second communication processing unit 143) communicates with a terminal apparatus (e.g., the terminal apparatus 400A) via the radio communication section 120.

(5) Implementation Example

The network communication section 110 may be implemented with a network adapter and/or a network interface card, and the like. The radio communication section 120 may be implemented with an antenna, a radio frequency (RF) circuit, and the like, and the antenna may be a directional antenna. The storage section 130 may be implemented with a memory (e.g., a nonvolatile memory and/or a volatile memory) and/or a hard disk, and the like. The processing section 140 may be implemented with one or more processors, such as a baseband (BB) processor and/or a different kind of processor. The first communication processing unit 141, the second communication processing unit 143, and the information obtaining unit 145 may be implemented with the same processor or may be implemented with separate processors. The memory (storage section 130) may be included in the one or more processors or may be provided outside the one or more processors.

The base station 100 may include a memory configured to store a program (instructions) and one or more processors that can execute the program (instructions). The one or more processors may execute the program and thereby perform operations of the processing section 140 (operations of the first communication processing unit 141, the second communication processing unit 143, and/or the information obtaining unit 145). The program may be a program for causing the processor(s) to execute operations of the processing section 140 (operations of the first communication processing unit 141, the second communication processing unit 143, and/or the information obtaining unit 145).

Note that the base station 100 may be virtual. In other words, the base station 100 may be implemented as a virtual machine. In this case, the base station 100 (the virtual machine) may operate as a physical machine (hardware) including a processor, a memory, and the like, and a virtual machine on a hypervisor.

<1.2.2. Configuration of Base Station 200>

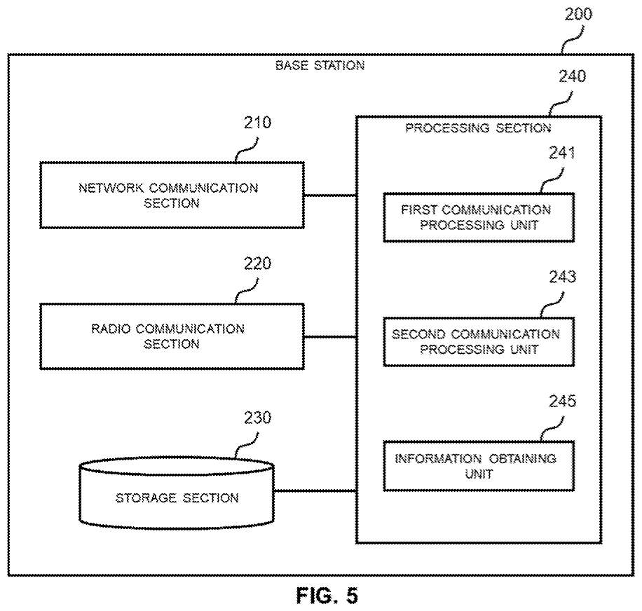

FIG. 5 is a block diagram illustrating an example of a schematic configuration of the base station 200 according to the first example embodiment. With reference to FIG. 5, the base station 200 includes a network communication section 210, a radio communication section 220, a storage section 230, and a processing section 240.

(1) Network Communication Section 210

The network communication section 210 receives a signal from a network and transmits a signal to the network.

(2) Radio Communication Section 220

The radio communication section 220 wirelessly transmits and/or receives a signal. For example, the radio communication section 220 receives a signal from a terminal apparatus and transmits a signal to the terminal apparatus.

(3) Storage Section 230

The storage section 230 temporarily or permanently stores programs (instructions) and parameters for operations of the base station 200 as well as various data. The program includes one or more instructions for operations of the base station 200.

(4) Processing Section 240

The processing section 240 provides various functions of the base station 200. The processing section 240 includes a first communication processing unit 241, a second communication processing unit 243, and an information obtaining unit 245. Note that the processing section 240 may further include constituent elements other than these constituent elements. In other words, the processing section 240 may also perform operations other than the operations of these constituent elements. Concrete operations of the first communication processing unit 241, the second communication processing unit 243, and the information obtaining unit 245 will be described later in detail.

For example, the processing section 240 (the first communication processing unit 241) communicates with a different network node (e.g., the base station 100 or the base station 300) via the network communication section 210. For example, the processing section 240 (the second communication processing unit 243) communicates with a terminal apparatus (e.g., the terminal apparatus 400B) via the radio communication section 220.

(5) Implementation Example

The network communication section 210 may be implemented with a network adapter and/or a network interface card, and the like. The radio communication section 220 may be implemented with an antenna, a radio frequency (RF) circuit, and the like, and the antenna may be a directional antenna. The storage section 230 may be implemented with a memory (e.g., a nonvolatile memory and/or a volatile memory) and/or a hard disk, and the like. The processing section 240 may be implemented with one or more processors, such as a baseband (BB) processor and/or a different kind of processor. The first communication processing unit 241, the second communication processing unit 243, and the information obtaining unit 245 may be implemented with the same processor or may be implemented with separate processors. The memory (storage section 230) may be included in the one or more processors or may be provided outside the one or more processors.

The base station 200 may include a memory configured to store a program (instructions) and one or more processors that can execute the program (instructions). The one or more processors may execute the program and thereby perform operations of the processing section 240 (operations of the first communication processing unit 241, the second communication processing unit 243, and/or the information obtaining unit 245). The program may be a program for causing the processor(s) to execute operations of the processing section 240 (operations of the first communication processing unit 241, the second communication processing unit 243, and/or the information obtaining unit 245).

Note that the base station 200 may be virtual. In other words, the base station 200 may be implemented as a virtual machine. In this case, the base station 200 (the virtual machine) may operate as a physical machine (hardware) including a processor, a memory, and the like, and a virtual machine on a hypervisor.

<1.2.3. Configuration of Base Station 300>

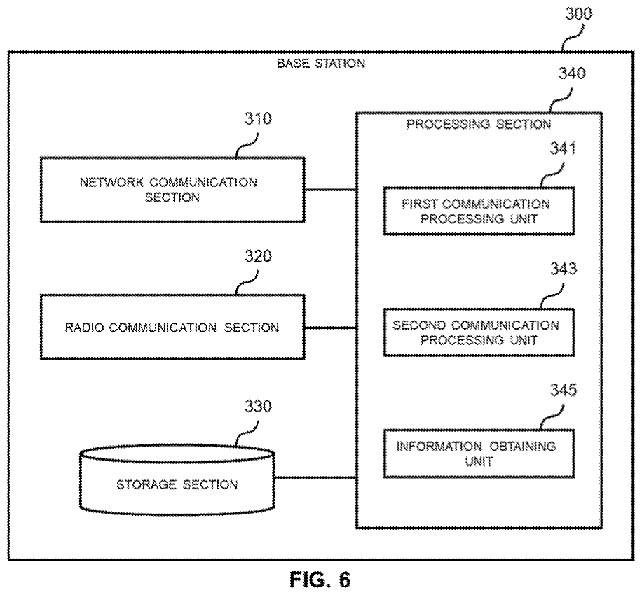

FIG. 6 is a block diagram illustrating an example of a schematic configuration of the base station 300 according to the first example embodiment. With reference to FIG. 6, the base station 300 includes a network communication section 310, a radio communication section 320, a storage section 330, and a processing section 340.

(1) Network Communication Section 310

The network communication section 310 receives a signal from a network and transmits a signal to the network.

(2) Radio Communication Section 320

The radio communication section 320 wirelessly transmits and/or receives a signal. For example, the radio communication section 320 receives a signal from a terminal apparatus and transmits a signal to the terminal apparatus.

(3) Storage Section 330

The storage section 330 temporarily or permanently stores programs (instructions) and parameters for operations of the base station 300 as well as various data. The program includes one or more instructions for operations of the base station 300.

(4) Processing Section 340

The processing section 340 provides various functions of the base station 300. The processing section 340 includes a first communication processing unit 341, a second communication processing unit 343, and an information obtaining unit 345. Note that the processing section 340 may further include constituent elements other than these constituent elements. In other words, the processing section 340 may also perform operations other than the operations of these constituent elements. Concrete operations of the first communication processing unit 341, the second communication processing unit 343, and the information obtaining unit 345 will be described later in detail.

For example, the processing section 340 (the first communication processing unit 341) communicates with a different network node (e.g., the base station 100 or the base station 200) via the network communication section 310. For example, the processing section 340 (the second communication processing unit 343) communicates with a terminal apparatus (e.g., the terminal apparatus 400C) via the radio communication section 320.

(5) Implementation Example

The network communication section 310 may be implemented with a network adapter and/or a network interface card, and the like. The radio communication section 320 may be implemented with an antenna, a radio frequency (RF) circuit, and the like, and the antenna may be a directional antenna. The storage section 330 may be implemented with a memory (e.g., a nonvolatile memory and/or a volatile memory) and/or a hard disk, and the like. The processing section 340 may be implemented with one or more processors, such as a baseband (BB) processor and/or a different kind of processor. The first communication processing unit 341, the second communication processing unit 343, and the information obtaining unit 345 may be implemented with the same processor or may be implemented with separate processors. The memory (storage section 330) may be included in the one or more processors or may be provided outside the one or more processors.

The base station 300 may include a memory configured to store a program (instructions) and one or more processors that can execute the program (instructions). The one or more processors may execute the program and thereby perform operations of the processing section 340 (operations of the first communication processing unit 341, the second communication processing unit 343, and/or the information obtaining unit 345). The program may be a program for causing the processor(s) to execute operations of the processing section 340 (operations of the first communication processing unit 341, the second communication processing unit 343, and/or the information obtaining unit 345).

Note that the base station 300 may be virtual. In other words, the base station 300 may be implemented as a virtual machine. In this case, the base station 300 (the virtual machine) may operate as a physical machine (hardware) including a processor, a memory, and the like, and a virtual machine on a hypervisor.

<1.2.4. Configuration of Terminal Apparatus 400>

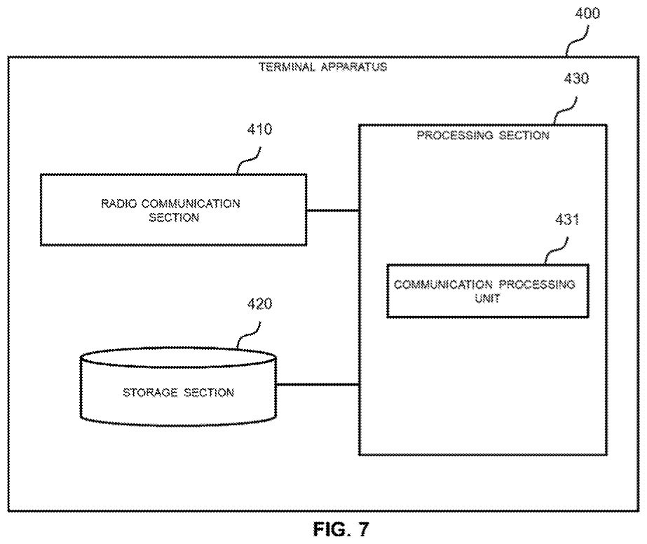

FIG. 7 is a block diagram illustrating an example of a schematic configuration of the terminal apparatus 400 according to the first example embodiment. With reference to FIG. 7, the terminal apparatus 400 includes a radio communication section 410, a storage section 420, and a processing section 430.

(1) Radio Communication Section 410

The radio communication section 410 wirelessly transmits and/or receives a signal. For example, the radio communication section 410 receives a signal from a base station and transmits a signal to the base station.

(2) Storage Section 420

The storage section 420 temporarily or permanently stores programs (instructions) and parameters for operations of the terminal apparatus 400 as well as various data. The program includes one or more instructions for the operations of the terminal apparatus 400.

(3) Processing Section 430

The processing section 430 provides various functions of the terminal apparatus 400. The processing section 430 includes a communication processing unit 431. Note that the processing section 430 may further include constituent elements other than this constituent element. In other words, the processing section 430 may also perform operations other than the operations of this constituent element. Concrete operations of the communication processing unit 431 will be described later in detail.

For example, the processing section 430 (the communication processing unit 431) communicates with a base station via the radio communication section 410.

(4) Implementation Example

The radio communication section 410 may be implemented with an antenna, a radio frequency (RF) circuit, and the like. The storage section 420 may be implemented with a memory (e.g., a nonvolatile memory and/or a volatile memory) and/or a hard disk, and the like. The processing section 430 may be implemented with one or more processors, such as a baseband (BB) processor and/or a different kind of processor. The memory (storage section 420) may be included in the one or more processors or may be provided outside the one or more processors. As an example, the processing section 430 may be implemented in a system on chip (SoC).

The terminal apparatus 400 may include a memory configured to store a program (instructions) and one or more processors that can execute the program (instructions). The one or more processors may execute the program and thereby perform operations of the processing section 430 (operations of the communication processing unit 431). The program may be a program for causing the processor(s) to execute operations of the processing section 430 (operations of the communication processing unit 431).

<<1.3. Technical Features>>

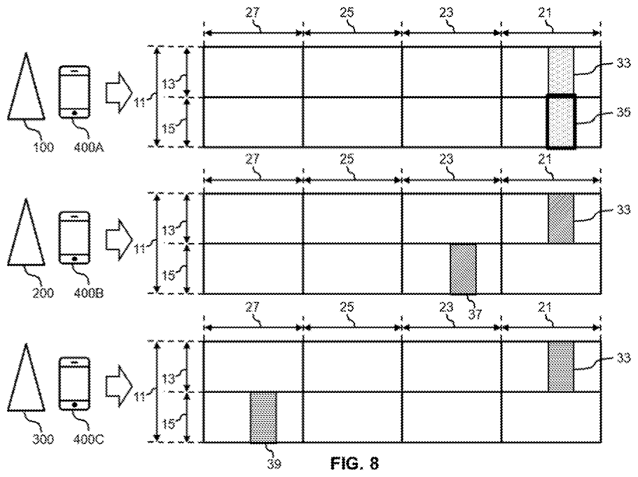

Technical features of the first example embodiment will be described with reference to FIGS. 8 to 10.

(1) Transmission of Hopping Pattern Control Information

The base station 100 (the information obtaining unit 145) obtains hopping pattern control information related to a pattern of frequency hopping for a terminal apparatus. The base station 100 (the first communication processing unit 141) transmits the hopping pattern control information to the base station 200 and the base station 300.

Terminal Apparatus

For example, the terminal apparatus is a terminal apparatus for which SPS is employed.

For example, the terminal apparatus is the terminal apparatus 400A that communicates with the base station 100. In other words, the base station 100 transmits, to the base station 200 and the base station 300, hopping pattern control information related to a frequency hopping pattern for the terminal apparatus 400A that communicates with the base station 100 itself

Frequency Hopping

For example, the frequency hopping is uplink frequency hopping. Specifically, for example, the frequency hopping is PUSCH frequency hopping. As an example, the frequency hopping is Type-1 hopping.

For example, the frequency hopping is intra-subframe frequency hopping. Specifically, in the frequency hopping, the frequency resource used in a second slot in a subframe used by the terminal apparatus is different from the frequency resource used by the terminal apparatus in a first slot in the subframe.

Hopping Pattern Control Information

For example, the hopping pattern control information indicates a pattern of the frequency hopping for the terminal apparatus. More specifically, for example, the hopping pattern control information indicates one of a plurality of frequency hopping patterns as the pattern of the frequency hopping for the terminal apparatus (e.g., the terminal apparatus 400A that communicates with the base station 100). As an example, when the frequency hopping is Type-1 hopping for PUSCH, the hopping pattern control information indicates one of three frequency hopping patterns.

When frequency hopping is not performed for the terminal apparatus (e.g., the terminal apparatus 400A that communicates with the base station 100), the hopping pattern control information may indicate no frequency hopping as the pattern of the frequency hopping for the terminal apparatus.

Note that the hopping pattern control information may be different information (auxiliary information) for specifying the frequency hopping for the terminal apparatus, instead of information indicating the pattern itself of the frequency hopping for the terminal apparatus.

Different Information

For example, the base station 100 transmits not only the hopping pattern control information but also different information to the base station 200 and the base station 300.

For example, the base station 100 (the information obtaining unit 145) obtains the hopping pattern control information and subframe information indicating a subframe in which the pattern of the frequency hopping is to be used. The base station 100 (the first communication processing unit 141) transmits the hopping pattern control information and the subframe information to the base station 200 and the base station 300.

Message

For example, the base station 100 (the first communication processing unit 141) transmits a message including the hopping pattern control information (and the subframe information) to the base station 200 and the base station 300.

For example, the message is an X2 message. Alternatively, the message may be an Xn message.

Transmission by Other Base Stations

Note that not only the base station 100 but also the base station 200 and the base station 300 may also transmit hopping pattern control information.

For example, the base station 200 (the information obtaining unit 245 and the first communication processing unit 241) may obtain hopping pattern control information related to a pattern of frequency hopping for the terminal apparatus 400B that communicates with the base station 200 (referred to as “second hopping pattern control information” below) and transmit the second hopping pattern control information to the base station 100 (and the base station 300). The base station 100 (the first communication processing unit 141) may receive the second hopping pattern control information from the base station 200. For example, the terminal apparatus 400B is a terminal apparatus for which SPS is employed.

For example, the base station 300 (the information obtaining unit 345 and the first communication processing unit 341) may obtain hopping pattern control information related to a pattern of frequency hopping for the terminal apparatus 400C that communicates with the base station 300 (referred to as “third hopping pattern control information” below) and transmit the third hopping pattern control information to the base station 100 (and the base station 200).

The base station 100 (the first communication processing unit 141) may receive the third hopping pattern control information from the base station 300. For example, the terminal apparatus 400C may be a terminal apparatus for which SPS is employed.

With such transmission of hopping pattern control information between the base stations, it is possible to configure such that, for example, base stations use different frequency hopping patterns (for the terminal apparatuses for which SPS is employed). As a result, it may be possible to reduce interference in a radio access network and improve communication.

(2) Selection of Frequency Hopping Pattern

As described above, the base station 100 transmits, to the base station 200 and the base station 300, hopping pattern control information related to a pattern of frequency hopping for the terminal apparatus 400A that communicates with the base station 100.

For example, the base station 100 (the second communication processing unit 143) selects the pattern of the frequency hopping for the terminal apparatus 400A.

For example, in a case that the base station 100 has received the second hopping pattern control information from the base station 200, the base station 100 (the second communication processing unit 143) selects the pattern of the frequency hopping for the terminal apparatus 400A, based on the second hopping pattern control information. For example, in a case that the base station 100 has received the third hopping pattern control information from the base station 300, the base station 100 (the second communication processing unit 143) selects the pattern of the frequency hopping for the terminal apparatus 400A, based on the third hopping pattern control information.

Specifically, for example, the base station 100 (the second communication processing unit 143) selects a different frequency hopping pattern from frequency hopping patterns indicated by the second hopping pattern control information and the third hopping pattern control information, as a frequency hopping pattern for the terminal apparatus 400A. Specifically, the base station 100 (the second communication processing unit 143) selects a different frequency hopping pattern from frequency hopping patterns for the terminal apparatus 400B and the terminal apparatus 400C, as the frequency hopping pattern for the terminal apparatus 400A.

With such selection of frequency hopping patterns, it is possible to configure such that, for example, base stations use different frequency hopping patterns (for the terminal apparatuses for which SPS is employed). As a result, it may be possible to reduce interference in a radio access network and improve communication.

Note that, since the number of frequency hopping patterns is limited, it is difficult to configure frequency hopping patterns (used for the terminal apparatuses for which SPS is employed) completely different from each other between base stations, in some cases. In such a case, the base stations may use the same frequency hopping pattern (for the terminal apparatuses for which SPS is employed). The base stations desirably use different frequency hopping patterns as much as possible.

Not only the base station 100 but also the base station 200 and the base station 300 may also select a frequency hopping pattern for the terminal apparatus 400B and a frequency hopping pattern for the terminal apparatus 400C, respectively, in a similar manner.

(3) Communication Using Frequency Hopping Pattern

For example, the base station 100 (the second communication processing unit 143) communicates with the terminal apparatus 400A in accordance with the pattern of the frequency hopping for the terminal apparatus 400A. The terminal apparatus 400A (the communication processing unit 431) communicates with the base station 100 in accordance with the pattern of the frequency hopping for the terminal apparatus 400A.

For example, the base station 100 (the second communication processing unit 143) transmits, to the terminal apparatus 400A, control information related to the pattern of the frequency hopping for the terminal apparatus 400A, and the terminal apparatus 400A (the communication processing unit 431) receives the control information. The terminal apparatus 400A (the communication processing unit 431) transmits an uplink signal to the base station 100 in accordance with the pattern of the frequency hopping indicated by the control information.

The base station 100 (the second communication processing unit 143) receives the uplink signal from the terminal apparatus 400A in accordance with the pattern of the frequency hopping.

For example, the control information is downlink control information (DCI), and the base station 100 (the second communication processing unit 143) transmits the control information on a physical downlink control channel (PDCCH). Alternatively, the control information may be a radio resource control (RRC) message.

(4) Measurement

For example, the base station 100 (the second communication processing unit 143) performs measurement in radio resources for SPS for the terminal apparatus 400A.

(4-1) First Example: Measurement of Received Power from Terminal Apparatus

As a first example, the measurement is measurement of a received power from the terminal apparatus 400A in the radio resources.

For example, it is assumed that, when the pattern of the frequency hopping for the terminal apparatus 400A is different from the frequency hopping patterns indicated by the second hopping pattern control information and the third hopping pattern control information, long-term interference due to SPS is not so large. Hence, for example, in such a case, the base station 100 (the second communication processing unit 143) measures a received power from the terminal apparatus 400A in radio resources for SPS for the terminal apparatus 400A.

For example, the radio resources (for which the measurement is performed) are radio resources allocated to SPS for the terminal apparatus 400A.

Concrete Example of Measurement

FIG. 8 is an explanatory diagram for illustrating an example of a frequency hopping pattern and measurement of a received power in the first example embodiment. With reference to FIG. 8, radio resources 33 and 35 allocated to the terminal apparatus 400A by the base station 100, radio resources 33 and 37 allocated to the terminal apparatus 400B by the base station 200, and radio resources 33 and 39 allocated to the terminal apparatus 400C by the base station 300 are illustrated. The terminal apparatus 400A uses the radio resource 33 and the radio resource 35, which have the same frequency resources, to transmit an uplink signal without performing frequency hopping. The terminal apparatus 400B performs frequency hopping with a frequency offset of ¼ of a PUSCH frequency region, and uses the radio resource 33 and the radio resource 37 to transmit an uplink signal. The terminal apparatus 400C performs frequency hopping with a frequency offset of −¼ of a PUSCH frequency region, and uses the radio resource 33 and the radio resource 39 to transmit an uplink signal. For example, the base station 100 (the second communication processing unit 143) measures a received power from the terminal apparatus 400A in the radio resource 35 not used by the terminal apparatus 400B and the terminal apparatus 400C but used by the terminal apparatus 400A.

Operation Based on Measurement Result

For example, the base station 100 (the second communication processing unit 143) determines whether to change a transmit power or a modulation and coding scheme (MCS) of the terminal apparatus 400A, based on a result of the measurement.

In this way, for example, it is possible for the terminal apparatus 400A to use a more appropriate transmit power or modulation and coding scheme.

(4-2) Second Example: Measurement of Interference

As a second example, the measurement may be measurement of interference from one or more different terminal apparatuses in the radio resources.

For example, it is assumed that, when the pattern of the frequency hopping for the terminal apparatus 400A is the same as the frequency hopping pattern indicated by the second hopping pattern control information or the third hopping pattern control information, long-term interference due to SPS may occur. Hence, for example, in such a case, the base station 100 (the second communication processing unit 143) may measure interference from one or more different terminal apparatuses (the terminal apparatus 400B and/or the terminal apparatus 400C) in radio resources for SPS for the terminal apparatus 400A.

The radio resources (for which the measurement is performed) may be radio resources allocated to SPS for the terminal apparatus 400A. Alternatively, the radio resources (for which the measurement is performed) may be radio resources to be allocated to SPS for the terminal apparatus 400A.

A pattern of frequency hopping for the one or more different terminal apparatuses (e.g., the terminal apparatus 400B and/or the terminal apparatus 400C) may be different from the pattern of the frequency hopping for the terminal apparatus 400A.

Concrete Example of Measurement

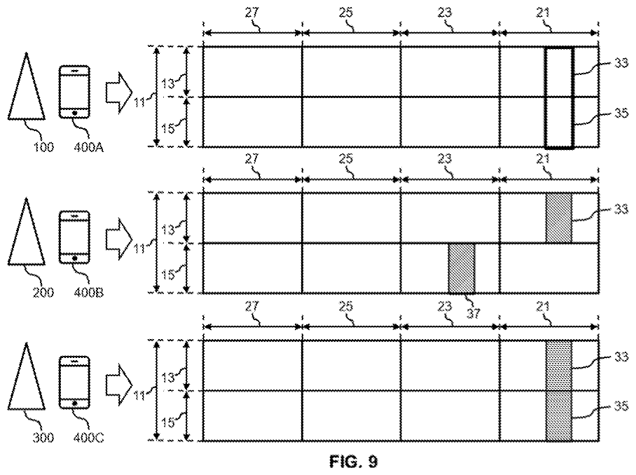

FIG. 9 is an explanatory diagram for illustrating an example of a frequency hopping pattern and measurement of interference in the first example embodiment. With reference to FIG. 9, the radio resources 33 and 35 allocated to the terminal apparatus 400A by the base station 100 (or the radio resources 33 and 35 to be allocated to the terminal apparatus 400A by the base station 100) are illustrated. In addition, the radio resources 33 and 37 allocated to the terminal apparatus 400B by the base station 200 and the radio resources 33 and 35 allocated to the terminal apparatus 400C by the base station 300 are illustrated. The terminal apparatus 400A does not use the radio resource 33 and the radio resource 35 to transmit an uplink signal. The terminal apparatus 400B performs frequency hopping with a frequency offset of ¼ of a PUSCH frequency region, and uses the radio resource 33 and the radio resource 37 to transmit an uplink signal. The terminal apparatus 400C uses the radio resource 33 and the radio resource 35, which have the same frequency resources, to transmit an uplink signal without performing frequency hopping. First, the base station 100 (the second communication processing unit 143) measures interference in the radio resource 33 (the sum of interference (received power) from the terminal apparatus 400B and interference (received power) from the terminal apparatus 400C) (referred to as “first measurement” below). Next, the base station 100 (the second communication processing unit 143) measures interference in the radio resource 35 (interference (received power) from the terminal apparatus 400C) (referred to as “second measurement” below). The base station 100 (the second communication processing unit 143) then subtracts a result of the second measurement from a result of the first measurement to thereby calculate interference from the terminal apparatus 400B. In this way, interference from each of the terminal apparatus 400B and the terminal apparatus 400C in the base station 100 is calculated.

Operation Based on Measurement Result

The base station 100 (the second communication processing unit 143) may determine whether to continue the SPS for the terminal apparatus 400A, based on a result of the measurement.

When the interference is small, the base station 100 (the second communication processing unit 143) may determine to continue the SPS for the terminal apparatus 400A.

When the interference is large, the base station 100 (the second communication processing unit 143) may determine to terminate the SPS for the terminal apparatus 400A (i.e., to switch to dynamic scheduling). Alternatively, when the interference is large, the base station 100 (the second communication processing unit 143) may determine to change the radio resources for the SPS for the terminal apparatus 400A or to change the frequency hopping pattern for the terminal apparatus 400A.

In this way, for example, it is possible for the terminal apparatus 400A to perform more desirable communication.

(5) Flow of Processing

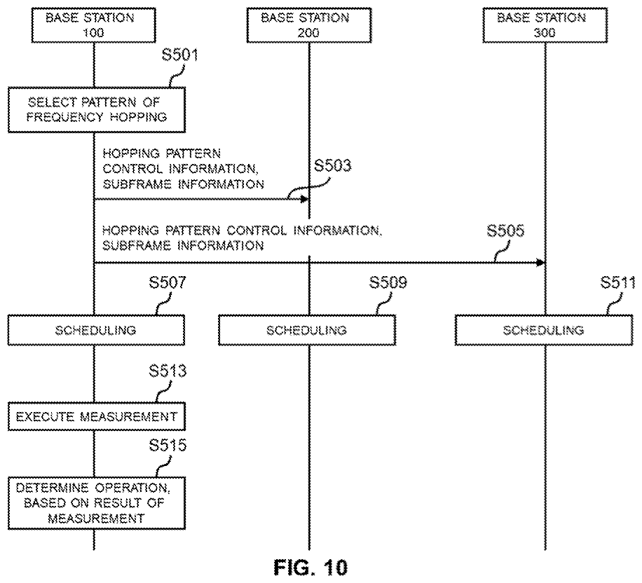

FIG. 10 is a sequence diagram for illustrating an example of a schematic flow of processing according to the first example embodiment.

The base station 100 selects a pattern of frequency hopping for the terminal apparatus 400A that communicates with the base station 100 (S501).

The base station 100 transmits, to the base station 200 and the base station 300, hopping pattern control information related to the pattern of the frequency hopping and subframe information indicating a subframe in which the pattern of the frequency hopping is to be used (S503 and S505).

The base station 100, the base station 200, and the base station 300 perform scheduling for the subframe (S507, S509, and S511).

The base station 100 performs measurement in radio resources for SPS for the terminal apparatus 400A (measurement of a received power from the terminal apparatus 400A or measurement of interference from different terminal apparatuses) (S513).

The base station 100 determines an operation, based on a result of the measurement (S515). For example, the base station 100 may determine whether to change the transmit power or the MCS of the terminal apparatus 400A, based on the result of the measurement (the measurement of a received power from the terminal apparatus 400A). Alternatively, the base station 100 may determine whether to continue the SPS for the terminal apparatus 400A, based on the result of the measurement (the measurement of interference from different terminal apparatuses).

<1.4. Example Alterations>

Example alterations of the first example embodiment will be described.

(1) First Example Alteration

As described above, for example, the base station 100 (the first communication processing unit 141) transmits, to the base station 200 and the base station 300, a message including the hopping pattern control information (and the subframe information).

As a first example alteration, each of the base station 200 (the first communication processing unit 241) and the base station 300 (the first communication processing unit 341) may transmit a response message to the message, to the base station 100. The base station 100 (the first communication processing unit 141) may receive the response message from each of the base station 200 and the base station 300.

For example, the response message may indicate acceptance or rejection of the hopping pattern control information. For example, when a pattern indicated by the hopping pattern control information is not used for the terminal apparatus 400B that communicates with the base station 200, the base station 200 may transmit, to the base station 100, a response message indicating acceptance of the hopping pattern control information. For example, when a pattern indicated by the hopping pattern control information is used for the terminal apparatus 400B that communicates with the base station 200, the base station 200 may transmit, to the base station 100, a response message indicating rejection of the hopping pattern control information.

In this way, for example, the base station 200 and the base station 300 can control use of a hopping pattern by the terminal apparatus 400A that communicates with the base station 100. As a result, it may be possible to reduce interference in a radio access network.

(2) Second Example Alteration

As described above, for example, the base station 100 (the second communication processing unit 143) may perform the measurement of interference after selecting a pattern of frequency hopping for the terminal apparatus 400A.

As a second example alteration, the base station 100 (the second communication processing unit 143) may perform measurement of interference in radio resources before selecting a pattern of frequency hopping for the terminal apparatus 400A. The base station 100 (the second communication processing unit 143) may then select a pattern of frequency hopping for the terminal apparatus 400A, based on a result of the measurement. The base station 100 (the second communication processing unit 143) may select radio resources to be allocated to SPS for the terminal apparatus 400A, based on the result of the measurement.

With this, for example, it is possible to use a more appropriate frequency hopping pattern and/or radio resources for the terminal apparatus 400A.

(3) Third Example Alteration

As described above, for example, the frequency hopping for the terminal apparatus (e.g., the terminal apparatus 400A that communicates with the base station 100) is intra-subframe frequency hopping.

As a third example alteration, the frequency hopping for the terminal apparatus may be inter-subframe frequency hopping. Specifically, in the frequency hopping, a frequency resource used in a first subframe used by the terminal apparatus may be different from a frequency resource used by the terminal apparatus in a second subframe.

(4) Fourth Example Alteration

As described above, for example, the frequency hopping for the terminal apparatus (e.g., the terminal apparatus 400A that communicates with the base station 100) is uplink frequency hopping.

As a fourth example alteration, the frequency hopping for the terminal apparatus may be downlink frequency hopping. In this case, the terminal apparatus may be a terminal apparatus that employs narrow band Internet of Things (NB-IoT).

(5) Fifth Example Alteration

As described above, the base station 100 (the first communication processing unit 141) transmits, to the base station 200, hopping pattern control information related to a pattern of frequency hopping for a terminal apparatus. In addition, as described above, for example, the terminal apparatus is the terminal apparatus 400A that communicates with the base station 100.

As a fifth example alteration, the terminal apparatus may be the terminal apparatus 400B that communicates with the base station 200. Specifically, the base station 100 (the information obtaining unit 145) may select a pattern of frequency hopping for the terminal apparatus 400B that communicates with the base station 200 and transmit, to the base station 200, hopping pattern control information related to the pattern of the frequency hopping. In this way, the base station 100 may indicate a frequency hopping pattern for the terminal apparatus 400B, to the base station 200. As an example, the base station 100 may be a node that performs centralized control, and the base station 200 (and the base station 300) may be a node that operates in accordance with the control.

In the fifth example alteration, as in the first example alteration, the base station 200 (the first communication processing unit 241) may transmit, to the base station 100, a response message to a message (a message including the hopping pattern control information) from the base station 100. The response message may indicate acceptance or rejection of the hopping pattern control information.

### 2. Second Example Embodiment

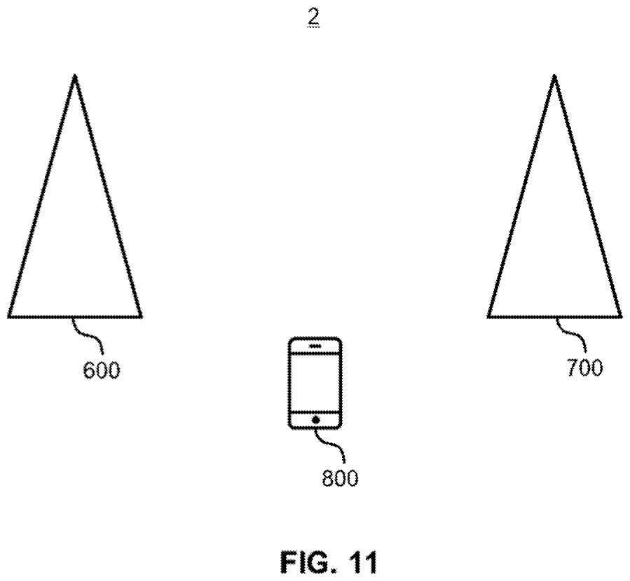

A description will be given of a second example embodiment with reference to FIGS. 11 to 14. The above-described first example embodiment is a concrete example embodiment, whereas the second example embodiment is a more generalized example embodiment.

<<2.1. Configuration of System>>

With reference to FIG. 11, an example of a configuration of a system 2 according to the second example embodiment will be described.

FIG. 11 is an explanatory diagram illustrating an example of a schematic configuration of the system 2 according to the second example embodiment. With reference to FIG. 11, the system 2 includes a base station 600, a base station 700, and a terminal apparatus 800. Although only one terminal apparatus 800 is illustrated in FIG. 11, the system 1 may include two or more terminal apparatuses 800.

For example, a description of the base station 600 is the same as that of the base station 100 in the first example embodiment. For example, a description of the base station 700 is the same as that of the base station 200 or the base station 300 in the first example embodiment.

For example, a description of the terminal apparatus 800 is the same as that of the terminal apparatus 400 in the first example embodiment. Hence, overlapping descriptions are omitted here.

<<2.2. Configuration of Each Node>>

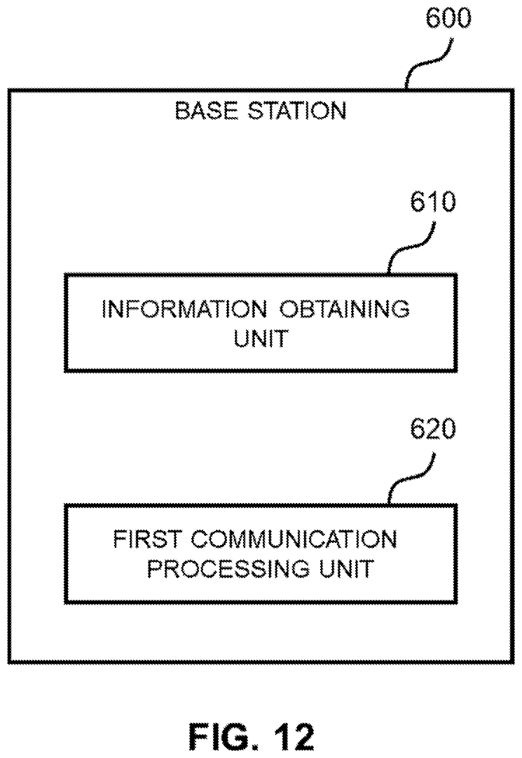

With reference to FIGS. 12 to 14, a configuration of each node according to the second example embodiment will be described.

<2.2.1. Configuration of Base Station 600>

FIG. 12 is a block diagram illustrating an example of a schematic configuration of the base station 600 according to the second example embodiment. With reference to FIG. 12, the base station 600 includes an information obtaining unit 610 and a first communication processing unit 620. Concrete operations of the information obtaining unit 610 and the first communication processing unit 620 will be described later.

The information obtaining unit 610 and the first communication processing unit 620 may be implemented with one or more processors, such as a baseband (BB) processor and/or a different kind of processor, a memory (e.g., a nonvolatile memory and/or a volatile memory), and/or a hard disk. The information obtaining unit 610 and the first communication processing unit 620 may be implemented with the same processor or may be implemented with separate processors. The memory may be included in the one or more processors or may be provided outside the one or more processors.

The base station 600 may include a memory configured to store a program (instructions) and one or more processors that can execute the program (instructions). The one or more processors may execute the program and thereby perform operations of the information obtaining unit 610 and the first communication processing unit 620. The program may be a program for causing the processor(s) to execute the operations of the information obtaining unit 610 and the first communication processing unit 620.

Note that the base station 600 may be virtual. In other words, the base station 600 may be implemented as a virtual machine. In this case, the base station 600 (the virtual machine) may operate as a physical machine (hardware) including a processor, a memory, and the like, and a virtual machine on a hypervisor.

<2.2.2. Configuration of Base Station 700>

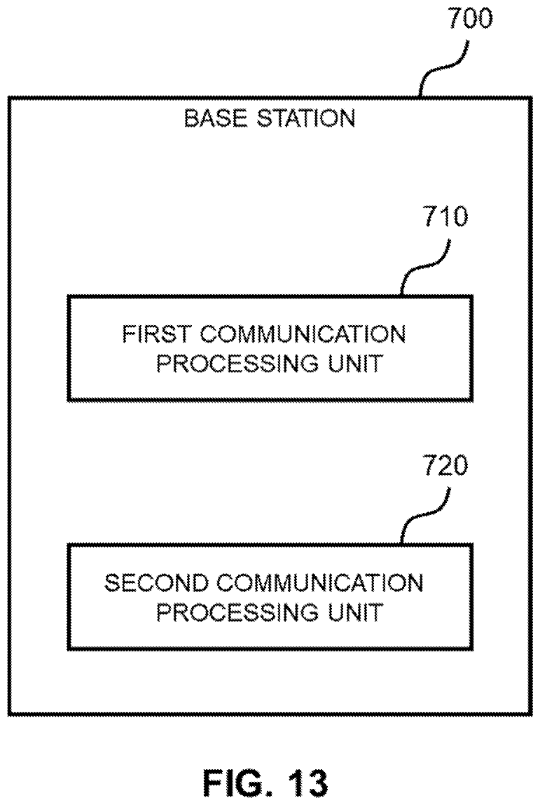

FIG. 13 is a block diagram illustrating an example of a schematic configuration of the base station 700 according to the second example embodiment. With reference to FIG. 13, the base station 700 includes a first communication processing unit 710 and a second communication processing unit 720. Concrete operations of the first communication processing unit 710 and the second communication processing unit 720 will be described later.

The first communication processing unit 710 and the second communication processing unit 720 may be implemented with one or more processors, such as a baseband (BB) processor and/or a different kind of processor, a memory (for example, a nonvolatile memory and/or a volatile memory), and/or a hard disk. The first communication processing unit 710 and the second communication processing unit 720 may be implemented with the same processor or may be implemented with separate processors. The memory may be included in the one or more processors or may be provided outside the one or more processors.

The base station 700 may include a memory configured to store a program (instructions) and one or more processors that can execute the program (instructions). The one or more processors may execute the program and thereby perform operations of the first communication processing unit 710 and the second communication processing unit 720. The program may be a program for causing the processor(s) to execute the operations of the first communication processing unit 710 and the second communication processing unit 720.

Note that the base station 700 may be virtual. In other words, the base station 700 may be implemented as a virtual machine. In this case, the base station 700 (the virtual machine) may operate as a physical machine (hardware) including a processor, a memory, and the like, and a virtual machine on a hypervisor.

<2.2.3. Configuration of Terminal Apparatus 800>

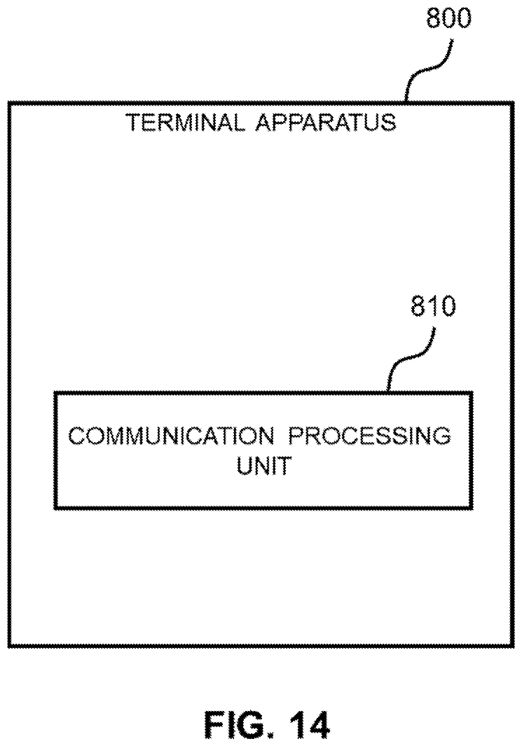

FIG. 14 is a block diagram illustrating an example of a schematic configuration of the terminal apparatus 800 according to the second example embodiment. With reference to FIG. 14, the terminal apparatus 800 includes a communication processing unit 810. Concrete operations of the communication processing unit 810 will be described later.

The communication processing unit 810 may be implemented with one or more processors, such as a baseband (BB) processor and/or a different kind of processor, a memory (e.g., a nonvolatile memory and/or a volatile memory), and/or a hard disk. The memory may be included in the one or more processors or may be provided outside the one or more processors. As an example, the communication processing unit 810 may be implemented within an SoC.

The terminal apparatus 800 may include a memory configured to store a program (instructions) and one or more processors that can execute the program (instructions). The one or more processors may execute the program and thereby perform operations of the communication processing unit 810. The program may be a program for causing the processor(s) to execute the operations of the communication processing unit 810.

<<2.3. Technical Features>>

Technical features of the second example embodiment will be described.

Base Station 600

The base station 600 (the information obtaining unit 610) obtains hopping pattern control information related to a pattern of frequency hopping for the terminal apparatus 800. The base station 600 (the first communication processing unit 620) transmits the hopping pattern control information to the base station 700.

For example, the terminal apparatus 800 may be a terminal apparatus for which SPS is employed.

For example, the terminal apparatus 800 is a terminal apparatus that communicates with the base station 600. Alternatively, the terminal apparatus 800 may be a terminal apparatus that communicates with the base station 700.

Base Station 700

The base station 700 (the first communication processing unit 710) receives the hopping pattern control information from the base station 600. The base station 700 (the second communication processing unit 720) communicates with a terminal apparatus, based on the hopping pattern control information.

For example, the terminal apparatus 800 is a terminal apparatus that communicates with the base station 600, and the base station 700 communicates with a different terminal apparatus. In this case, for example, the base station 700 selects a different frequency hopping pattern from a frequency hopping pattern indicated by the hopping pattern control information, to communicate with the different terminal apparatus in accordance with the different frequency hopping pattern.

Alternatively, the terminal apparatus 800 may be a terminal apparatus that communicates with the base station 700. In this case, for example, the base station 700 may communicate with the terminal apparatus 800 in accordance with the frequency hopping pattern indicated by the hopping pattern control information.

Terminal Apparatus 800

The terminal apparatus 800 (the communication processing unit 810) communicates with the base station 600 in accordance with a pattern of frequency hopping for the terminal apparatus 800.

Alternatively, the terminal apparatus 800 (the communication processing unit 810) may communicate with the base station 700 in accordance with the pattern of the frequency hopping for the terminal apparatus 800.

Relationship with First Example Embodiment

As an example, the base station 600, the base station 700, and the terminal apparatus 800 of the second example embodiment are the base station 100, the base station 200 (or the base station 300), and the terminal apparatus 400 (the terminal apparatus 400A or the terminal apparatus 400B) of the first example embodiment, respectively. In this case, the descriptions of the first example embodiment may be applicable to the second example embodiment.

Note that the second example embodiment is not limited to this example.

The second example embodiment has been described above. According to the second example embodiment, communication in a radio access network may be improved.

### 3. Third Example Embodiment

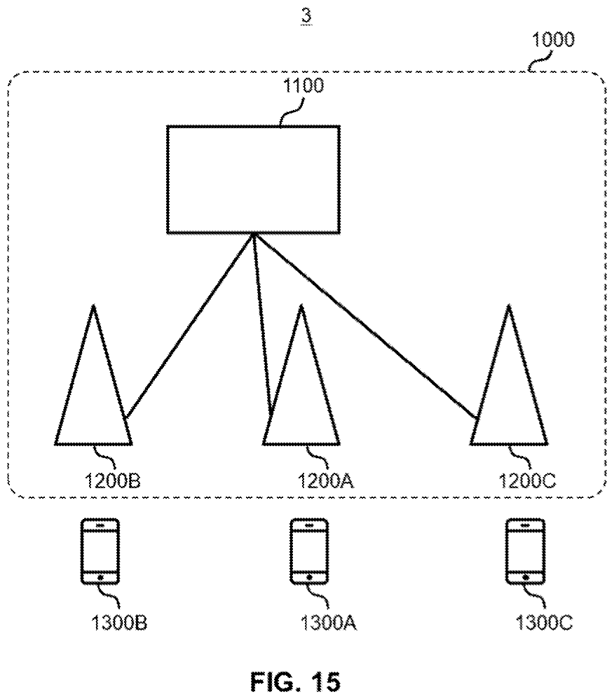

A description will be given of a third example embodiment with reference to FIGS. 15 to 20.

<<3.1. Configuration of System>>

With reference to FIG. 15, an example of a configuration of a system 3 according to the third example embodiment will be described.

FIG. 15 is an explanatory diagram illustrating an example of a schematic configuration of the system 3 according to the third example embodiment. With reference to FIG. 15, the system 3 includes a base station 1000 and terminal apparatuses 1300. The base station 1000 includes a first unit 1100 and second units 1200. Although three second units 1200 (second units 1200A, 1200B, and 1200C) are illustrated in FIG. 15, the base station 1000 may include four or more second units 1200 or may include only one or two second units 1200. In addition, although three terminal apparatuses 1300 (i.e., a terminal apparatus 1300A, a terminal apparatus 1300B, and a terminal apparatus 1300C) are illustrated in FIG. 15, the system 3 may include four or more terminal apparatuses 1300 and may include only one or two terminal apparatuses 1300.

For example, the system 3 is a system conforming to 3GPP standards/specifications. More specifically, for example, the system 1 may be a system conforming to LTE/LTE-Advanced standards/specifications. Alternatively, the system 1 may be a system conforming to fifth-generation (5G)/NR standards/specifications. The system 1 is, of course, not limited to these examples.

(1) Base Station 1000

The base station 1000 is a radio access network (RAN) node and is configured to perform radio communication with terminal apparatuses (e.g., the terminal apparatuses 1300) located in the coverage area of the base station 1000.

For example, the first unit 1100 performs processing of a higher layer protocol among protocols of a radio access network (RAN), and each second unit 1200 performs processing of a lower layer protocol among the protocols.

The base station 1000 may be an eNB. In this case, the first unit 1100 may be referred to as a digital unit (DU), and each second unit 1200 may be referred to as a radio unit (RU) or a remote unit (RU). The DU may be a BBU, and the RU may be an RRH or an RRU.

Alternatively, the base station 1000 may be a gNB in 5G. In this case, the first unit 1100 may be referred to as a central unit (CU), and each second unit 1200 may be referred to as a distributed unit (DU).

The second units 1200A, 1200B, and 1200C each have a coverage area and use the same radio resources.

(2) Terminal Apparatus 1300

The terminal apparatus 1300 (wirelessly) communicates with a base station. For example, the terminal apparatus 1300 communicates with the base station 1000 in a case of being located in the coverage area of the base station 1000. For example, the terminal apparatus 1300 communicates, in a case of being located within the coverage area of the second unit 1200, with the base station 1000 via this second unit 1200.

For example, as illustrated in FIG. 15, the terminal apparatus 1300A is connected to the base station 1000 via the second unit 1200A to communicate with the base station 1000. The terminal apparatus 1300B is connected to the base station 1000 via the second unit 1200B to communicate with the base station 1000. The terminal apparatus 1300C is connected to the base station 1000 via the second unit 1200C to communicate with the base station 1000.

For example, each terminal apparatus 1300 is a UE.

(3) Interference

For example, the base station 1000 may allocate the same radio resource (the same time-frequency resource) to the terminal apparatus 1300A, the terminal apparatus 1300B, and the terminal apparatus 1300C. In this case, interference may occur.

With reference to FIG. 2 again, for example, the base station 1000 allocates the radio resource 31 to the terminal apparatus 1300A, the terminal apparatus 1300B, and the terminal apparatus 1300C. The radio resource 31 is located at part of the subband 21 in the frequency direction and over the subframe 11 in the time direction.

For example, the terminal apparatus 1300A transmits a signal to the second unit 1200A, the terminal apparatus 1300B transmits a signal to the second unit 1200B, and the terminal apparatus 1300C transmits a signal to the second unit 1200C. These signals are desired signals for the respective second units 1200A, 1200B, and 1200C. However, for example, the terminal apparatus 1300B is located near the boundary between the coverage of the second unit 1200B and the coverage of the second unit 1200A, and hence a signal from the terminal apparatus 1300B reaches the second unit 1200A. This signal may be an interference signal for the second unit 1200A. For example, the terminal apparatus 1300C is located near the boundary between the coverage of the second unit 1200C and the coverage of the second unit 1200A, and hence a signal from the terminal apparatus 1300C reaches the second unit 1200A. This signal may be an interference signal for the second unit 1200A.

Especially in a case that SPS is employed for the terminal apparatus 1300A, the terminal apparatus 1300B, and the terminal apparatus 1300C, this interference may continue over a long period.

In the third example embodiment, for example, the terminal apparatus 1300A, the terminal apparatus 1300B, and the terminal apparatus 1300C employ frequency hopping. When the pattern of frequency hopping for the terminal apparatus 1300A is the same as the patterns of frequency hopping for the terminal apparatus 1300B and the terminal apparatus 1300C, the interference in the second unit 1200A is not reduced. In contrast, when the pattern of frequency hopping for the terminal apparatus 1300A is different from the patterns of frequency hopping for the terminal apparatus 1300B and the terminal apparatus 1300C, the interference in the second unit 1200A may be reduced.

<<3.2. Configuration of Each Node>>

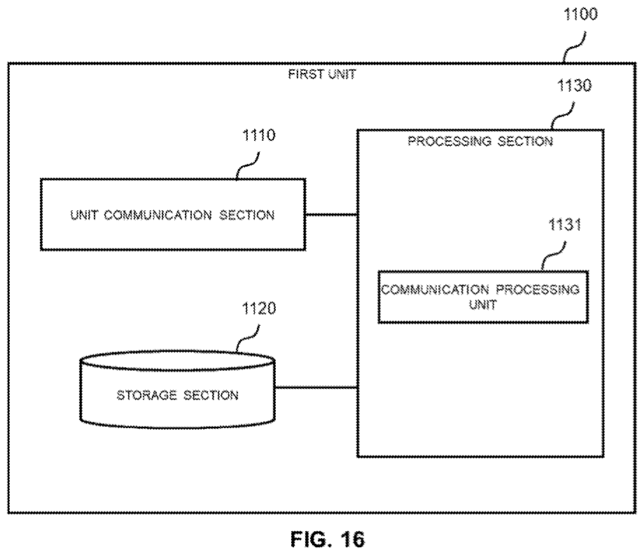

With reference to FIGS. 16 to 18, a configuration of each node according to the third example embodiment will be described.

<3.2.1. Configuration of First Unit 1100>

FIG. 16 is a block diagram illustrating an example of a schematic configuration of the first unit 1100 according to the third example embodiment. With reference to FIG. 16, the first unit 1100 includes a unit communication section 1110, a storage section 1120, and a processing section 1130.

(1) Unit Communication Section 1110

The unit communication section 1110 receives a signal from the second unit 1200 and transmits a signal to the second unit 1200.

(2) Storage Section 1120

The storage section 1120 temporarily or permanently stores programs (instructions) and parameters for operations of the first unit 1100 as well as various data. The program includes one or more instructions for operations of the first unit 1100.

(3) Processing Section 1130

The processing section 1130 provides various functions of the first unit 1100. The processing section 1130 includes a communication processing unit 1131. Note that the processing section 1130 may further include constituent elements other than this constituent element. In other words, the processing section 1130 may also perform operations other than the operations of this constituent element.

For example, the processing section 1130 (the communication processing unit 1131) communicates with the second unit 1200 via the unit communication section 1110.

For example, the processing section 1130 (the communication processing unit 1131) communicates with the terminal apparatus 1300 via the unit communication section 1110 (and the second unit 1200).

(4) Implementation Example

The unit communication section 1110 may be implemented with a network adapter and/or a network interface card, and the like. The storage section 1120 may be implemented with a memory (e.g., a nonvolatile memory and/or a volatile memory) and/or a hard disk, and the like. The processing section 1130 may be implemented with one or more processors, such as a baseband (BB) processor and/or a different kind of processor. The memory (storage section 1120) may be included in the one or more processors or may be provided outside the one or more processors.

The first unit 1100 may include a memory configured to store a program (instructions) and one or more processors that can execute the program (instructions). The one or more processors may execute the program and thereby perform operations of the processing section 1130 (operations of the communication processing unit 1131). The program may be a program for causing the processor(s) to execute operations of the processing section 1130 (operations of the communication processing unit 1131).

Note that the first unit 1100 may be virtual. In other words, the first unit 1100 may be implemented as a virtual machine. In this case, the first unit 1100 (the virtual machine) may operate as a physical machine (hardware) including a processor, a memory, and the like, and a virtual machine on a hypervisor.

<3.2.2. Configuration of Second Unit 1200>

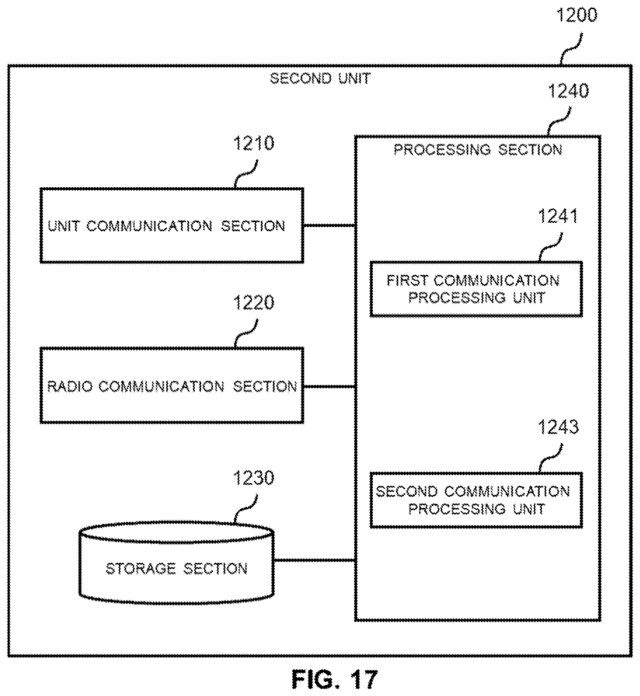

FIG. 17 is a block diagram illustrating an example of a schematic configuration of the second unit 1200 according to the third example embodiment. With reference to FIG. 17, the second unit 1200 includes a unit communication section 1210, a radio communication section 1220, a storage section 1230, and a processing section 1240.

(1) Unit Communication Section 1210

The unit communication section 1210 receives a signal from the first unit 1100 and transmits a signal to the first unit 1100.

(2) Radio Communication Section 1220

The radio communication section 1220 wirelessly transmits and/or receives a signal. For example, the radio communication section 1220 receives a signal from a terminal apparatus and transmits a signal to the terminal apparatus.

(3) Storage Section 1230

The storage section 1230 temporarily or permanently stores programs (instructions) and parameters for operations of the second unit 1200 as well as various data. The program includes one or more instructions for operations of the second unit 1200.

(4) Processing Section 1240

The processing section 1240 provides various functions of the second unit 1200. The processing section 1240 includes a first communication processing unit 1241 and a second communication processing unit 1243. Note that the processing section 1240 may further include constituent elements other than these constituent elements. In other words, the processing section 1240 may also perform operations other than the operations of these constituent elements.

For example, the processing section 1240 (the first communication processing unit 1241) communicates with the first unit 1100 via the unit communication section 1210. For example, the processing section 1240 (the second communication processing unit 1243) communicates with a terminal apparatus (e.g., the terminal apparatus 1300) via the radio communication section 1220.

(5) Implementation Example

The unit communication section 1210 may be implemented with a network adapter and/or a network interface card, and the like. The radio communication section 1220 may be implemented with an antenna, a radio frequency (RF) circuit, and the like, and the antenna may be a directional antenna. The storage section 1230 may be implemented with a memory (e.g., a nonvolatile memory and/or a volatile memory) and/or a hard disk, and the like. The processing section 1240 may be implemented with one or more processors, such as a baseband (BB) processor and/or a different kind of processor. The first communication processing unit 1241 and the second communication processing unit 1243 may be implemented with the same processor or may be implemented with separate processors. The memory (storage section 1230) may be included in the one or more processors or may be provided outside the one or more processors.

The second unit 1200 may include a memory configured to store a program (instructions) and one or more processors that can execute the program (instructions). The one or more processors may execute the program and thereby perform operations of the processing section 1240 (operations of the first communication processing unit 1241 and the second communication processing unit 1243). The program may be a program for causing the processor(s) to execute the operations of the processing section 1240 (the operations of the first communication processing unit 1241 and the second communication processing unit 1243).

Note that the second unit 1200 may be virtual. In other words, the second unit 1200 may be implemented as a virtual machine. In this case, the second unit 1200 (the virtual machine) may operate as a physical machine (hardware) including a processor, a memory, and the like, and a virtual machine on a hypervisor.

<3.2.3. Configuration of Terminal Apparatus 1300>

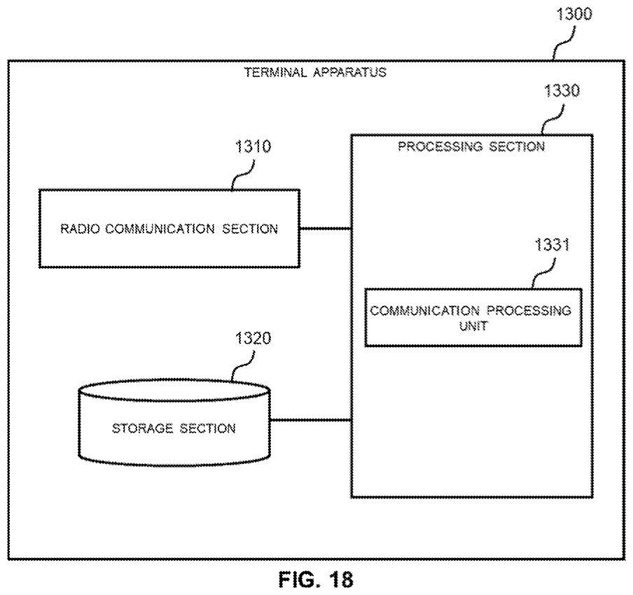

FIG. 18 is a block diagram illustrating an example of a schematic configuration of the terminal apparatus 1300 according to the third example embodiment. With reference to FIG. 18, the terminal apparatus 1300 includes a radio communication section 1310, a storage section 1320, and a processing section 1330.

(1) Radio Communication Section 1310

The radio communication section 1310 wirelessly transmits and/or receives a signal. For example, the radio communication section 1310 receives a signal from a base station and transmits a signal to the base station.

(2) Storage Section 1320

The storage section 1320 temporarily or permanently stores programs (instructions) and parameters for operations of the terminal apparatus 1300 as well as various data. The program includes one or more instructions for the operations of the terminal apparatus 1300.

(3) Processing Section 1330

The processing section 1330 provides various functions of the terminal apparatus 1300. The processing section 1330 includes a communication processing unit 1331. Note that the processing section 1330 may further include constituent elements other than this constituent element. In other words, the processing section 1330 may also perform operations other than the operations of this constituent element. Concrete operations of the communication processing unit 1331 will be described later in detail.

For example, the processing section 1330 (the communication processing unit 1331) communicates with a base station via the radio communication section 1310.

(4) Implementation Example

The radio communication section 1310 may be implemented with an antenna, a radio frequency (RF) circuit, and the like. The storage section 1320 may be implemented with a memory (e.g., a nonvolatile memory and/or a volatile memory) and/or a hard disk, and the like.

The processing section 1330 may be implemented with one or more processors, such as a baseband (BB) processor and/or a different kind of processor. The memory (storage section 1320) may be included in the one or more processors or may be provided outside the one or more processors. As an example, the processing section 1330 may be implemented within an SoC.

The terminal apparatus 1300 may include a memory configured to store a program (instructions) and one or more processors that can execute the program (instructions). The one or more processors may execute the program and thereby perform operations of the processing section 1330 (operations of the radio communication processing unit 1331). The program may be a program that causes a processor to execute operations of the processing section 1330 (operations of the radio communication processing unit 1331).

<<3.3. Technical Features>>

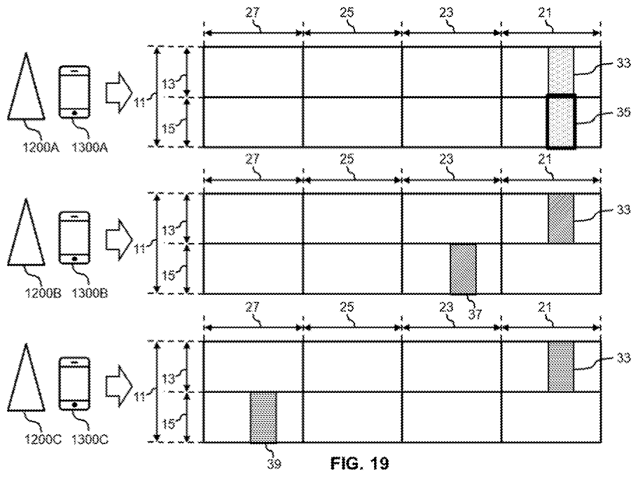

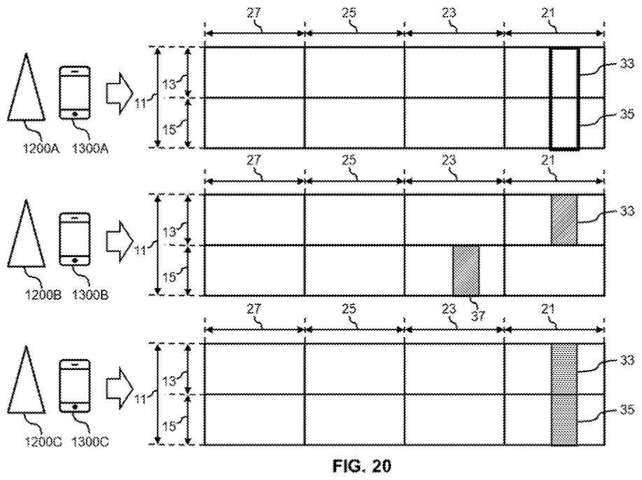

Technical features of the third example embodiment will be described with reference to FIGS. 19 and 20.

(1) Selection of Frequency Hopping Pattern

The first unit 1100 (the communication processing unit 1131) selects a pattern of frequency hopping for the terminal apparatus 1300 that communicates with the base station 1000.

For example, the terminal apparatus 1300 may be a terminal apparatus for which SPS is employed.

For example, the first unit 1100 (the communication processing unit 1131) selects a first pattern for the terminal apparatus 1300A that communicates with the second unit 1200A, a second pattern for the terminal apparatus 1300B that communicates with the second unit 1200B, and a third pattern for the terminal apparatus 1300C that communicates with the second unit 1200C.

The first unit 1100 (the communication processing unit 1131) selects the first pattern, the second pattern, and the third pattern so that the first pattern, the second pattern, and the third pattern would be different from each other, as much as possible.

With such selection of frequency hopping patterns, it is possible to configure such that, for example, base stations use different frequency hopping patterns (for the terminal apparatuses for which SPS is employed). As a result, it may be possible to reduce interference in a radio access network and improve communication.

Note that, since the number of frequency hopping patterns is limited, it is difficult to configure frequency hopping patterns (used for the terminal apparatuses for which SPS is employed) completely different from each other between the second units 1200, in some cases. In such a case, the same frequency hopping pattern may be used among the second units 1200 (for the terminal apparatuses 1300 for which SPS is employed). The second units 1200 desirably use different frequency hopping patterns as much as possible.

(2) Communication Using Frequency Hopping Pattern

For example, the base station 1000 (the communication processing unit 1131 or the second communication processing unit 1243) communicates with the terminal apparatus 1300 in accordance with the pattern of the frequency hopping for the terminal apparatus 1300. The terminal apparatus 1300 (the communication processing unit 1331) communicates with the base station 1000 in accordance with the pattern of the frequency hopping for the terminal apparatus 1300.

For example, the base station 1000 (the communication processing unit 1131 or the second communication processing unit 1243) transmits, from the second unit 1200A to the terminal apparatus 1300A, control information related to the first pattern of the frequency hopping for the terminal apparatus 1300A. The terminal apparatus 1300A (the communication processing unit 1331) receives the control information. The terminal apparatus 1300A (the communication processing unit 1331) transmits an uplink signal to the base station 1000 (the second unit 1200A) in accordance with the first pattern of the frequency hopping indicated by the control information. The base station 1000 (the communication processing unit 1131 or the second communication processing unit 1243) receives the uplink signal from the terminal apparatus 1300A in accordance with the first pattern of the frequency hopping.

For example, the control information is DCI, and the base station 1000 (the communication processing unit 1131 or the second communication processing unit 1243) transmits the control information on a PDCCH. Alternatively, the control information may be an RRC message.

(3) Measurement

For example, the base station 1000 (the communication processing unit 1131 or the second communication processing unit 1243) performs measurement in radio resources for SPS for the terminal apparatus 1300A.

(3-1) First Example: Measurement of Received Power from Terminal Apparatus

As a first example, the measurement is measurement of a received power from the terminal apparatus 1300A in the radio resources.

For example, it is assumed that, when the first pattern of frequency hopping for the terminal apparatus 1300A is different from the second pattern of frequency hopping for the terminal apparatus 1300B and the third pattern of frequency hopping for the terminal apparatus 1300C, long-term interference due to SPS is not so large. Hence, for example, in such a case, the base station 1000 (the communication processing unit 1131 or the second communication processing unit 1243) measures a received power from the terminal apparatus 1300A in radio resources for SPS for the terminal apparatus 1300A.

For example, the radio resources (for which the measurement is performed) are radio resources allocated to SPS for the terminal apparatus 1300A.

Concrete Example of Measurement

FIG. 19 is an explanatory diagram for illustrating an example of a frequency hopping pattern and measurement of a received power in the third example embodiment. With reference to FIG. 19, radio resources 33 and 35 allocated to the terminal apparatus 1300A by the base station 1000, radio resources 33 and 37 allocated to the terminal apparatus 1300B by the base station 1000, and radio resources 33 and 39 allocated to the terminal apparatus 1300C by the base station 1000 are illustrated. The terminal apparatus 1300A uses the radio resource 33 and the radio resource 35, which have the same frequency resources, to transmit an uplink signal without performing frequency hopping. The terminal apparatus 1300B performs frequency hopping with a frequency offset of ¼ of a PUSCH frequency region, and uses the radio resource 33 and the radio resource 37 to transmit an uplink signal. The terminal apparatus 1300C performs frequency hopping with a frequency offset of −¼ of a PUSCH frequency region, and uses the radio resource 33 and the radio resource 39 to transmit an uplink signal.

For example, the base station 1000 (the communication processing unit 1131 or the second communication processing unit 1243) measures a received power from the terminal apparatus 1300A in the radio resource 35 not used by the terminal apparatus 1300B and the terminal apparatus 1300C but used by the terminal apparatus 1300A.

Operation Based on Measurement Result

For example, the base station 1000 (the communication processing unit 1131 or the second communication processing unit 1243) determines whether to change a transmit power or a modulation and coding scheme (MCS) of the terminal apparatus 1300A, based on a result of the measurement.

In this way, for example, it is possible for the terminal apparatus 1300A to use a more appropriate transmit power or modulation and coding scheme.

(3-2) Second Example: Measurement of Interference

As a second example, the measurement may be measurement of interference from one or more different terminal apparatuses in the radio resources.

For example, it is assumed that, when the first pattern of frequency hopping for the terminal apparatus 1300A is the same as the second pattern of frequency hopping for the terminal apparatus 1300B or the third pattern of frequency hopping for the terminal apparatus 1300C, long-term interference due to SPS may occur. Hence, for example, in such a case, the base station 1000 (the communication processing unit 1131 or the second communication processing unit 1243) may measure interference from one or more different terminal apparatuses (the terminal apparatus 1300B and/or the terminal apparatus 1300C) in radio resources for SPS for the terminal apparatus 1300A.

The radio resources (for which the measurement is performed) may be radio resources allocated to SPS for the terminal apparatus 1300A. Alternatively, the radio resources (for which the measurement is performed) may be radio resources to be allocated to SPS for the terminal apparatus 1300A.

A pattern of frequency hopping for the one or more different terminal apparatuses (e.g., the terminal apparatus 1300B and/or the terminal apparatus 1300C) may be different from the pattern of the frequency hopping for the terminal apparatus 1300A.

Concrete Example of Measurement

FIG. 20 is an explanatory diagram for illustrating an example of a frequency hopping pattern and measurement of interference in the third example embodiment. With reference to FIG. 20, the radio resources 33 and 35 allocated to the terminal apparatus 1300A by the base station 1000 (or the radio resources 33 and 35 to be allocated to the terminal apparatus 1300A by the base station 1000) are illustrated. In addition, the radio resources 33 and 37 allocated to the terminal apparatus 1300B by the base station 1000 and the radio resources 33 and 35 allocated to the terminal apparatus 1300C by the base station 1000 are illustrated. The terminal apparatus 1300A does not use the radio resource 33 and the radio resource 35 to transmit an uplink signal. The terminal apparatus 1300B performs frequency hopping with a frequency offset of ¼ of a PUSCH frequency region, and uses the radio resource 33 and the radio resource 37 to transmit an uplink signal to the second unit 1200B. The terminal apparatus 1300C uses the radio resource 33 and the radio resource 35, which have the same frequency resources, to transmit an uplink signal to the second unit 1200C without performing frequency hopping. First, the base station 1000 (the communication processing unit 1131 or the second communication processing unit 1243) measures interference in the radio resource 33 in the second unit 1200A (the sum of interference (received power) from the terminal apparatus 1300B and interference (received power) from the terminal apparatus 1300C) (referred to as “first measurement” below). Next, the base station 1000 (the communication processing unit 1131 or the second communication processing unit 1243) measures interference in the radio resource 35 in the second unit 1200A (interference (received power) from the terminal apparatus 1300C) (referred to as “second measurement” below). The base station 1000 (the communication processing unit 1131 or the second communication processing unit 1243) then subtracts a result of the second measurement from a result of the first measurement to thereby calculate interference from the terminal apparatus 1300B in the second unit 1200A. In this way, interference from each of the terminal apparatus 1300B and the terminal apparatus 1300C in the second unit 1200A is calculated.

Operation Based on Measurement Result

The base station 1000 (the communication processing unit 1131 or the second communication processing unit 1243) may determine whether to continue the SPS for the terminal apparatus 1300A, based on a result of the measurement.

When the interference is small, the base station 1000 (the communication processing unit 1131 or the second communication processing unit 1243) may determine to continue the SPS for the terminal apparatus 1300A.

When the interference is large, the base station 1000 (the communication processing unit 1131 or the second communication processing unit 1243) may determine to terminate the SPS for the terminal apparatus 1300A (i.e., to switch to dynamic scheduling). Alternatively, when the interference is large, the base station 1000 (the communication processing unit 1131 or the second communication processing unit 1243) may determine to change the radio resources for the SPS for the terminal apparatus 1300A or to change the frequency hopping pattern for the terminal apparatus 1300A.

In this way, for example, it is possible for the terminal apparatus 1300A to perform more desirable communication.

Although measurement in radio resources for SPS for the terminal apparatus 1300A has been described here, similar measurement may also be performed for the terminal apparatus 1300B and the terminal apparatus 1300C.

The third example embodiment has been described above. Note that similar example alterations as the second example alteration, the third example alteration, and the fourth example alteration of the first example embodiment may also be applied to the third example embodiment.

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including constituent elements (e.g., the various communication processing units and/or the information obtaining unit) of the base station described in the Specification (e.g., one or more apparatuses (or units) among a plurality of apparatuses (or units) configuring the base station or a module for one of the plurality of apparatuses (or units)) may be provided. An apparatus including the constituent elements (e.g., the communication processing unit) of the terminal apparatus described in the Specification (e.g., a module for the terminal apparatus) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

A first base station comprising:

an information obtaining unit configured to obtain hopping pattern control information related to a pattern of frequency hopping for a terminal apparatus; and

a first communication processing unit configured to transmit the hopping pattern control information to a second base station.

### (Supplementary Note 2)

The first base station according to Supplementary Note 1, wherein the terminal apparatus is a terminal apparatus for which semi-persistent scheduling (SPS) is employed.

### (Supplementary Note 3)

The first base station according to Supplementary Note 1 or 2, wherein the terminal apparatus is a terminal apparatus that communicates with the first base station.

### (Supplementary Note 4)

The first base station according to Supplementary Note 3, wherein

the information obtaining unit is configured to obtain the hopping pattern control information and subframe information indicating a subframe in which the pattern of the frequency hopping is to be used, and

the first communication processing unit transmits the hopping pattern control information and the subframe information to the second base station.

### (Supplementary Note 5)

The first base station according to Supplementary Note 3 or 4 further comprising a second communication processing unit configured to select the pattern of the frequency hopping.

### (Supplementary Note 6)

The first base station according to Supplementary Note 5, wherein

the first communication processing unit receives, from the second base station, different hopping pattern control information related to a pattern of frequency hopping for a different terminal apparatus that communicates with the second base station, and

the second communication processing unit selects the pattern of the frequency hopping for the terminal apparatus that communicates with the first base station, based on the different hopping pattern control information.

### (Supplementary Note 7)

The first base station according to any one of Supplementary Notes 1 to 6 further comprising a second communication processing unit configured to communicate with the terminal apparatus in accordance with the pattern of the frequency hopping.

### (Supplementary Note 8)

The first base station according to any one of Supplementary Notes 1 to 7, wherein the terminal apparatus is a terminal apparatus for which SPS is employed,

the first base station further comprises a second communication processing unit configured to perform measurement in radio resources for the SPS for the terminal apparatus.

### (Supplementary Note 9)

The first base station according to Supplementary Note 8, wherein the measurement is measurement of interference from one or more different terminal apparatuses in the radio resources.

### (Supplementary Note 10)

The first base station according to Supplementary Note 9 further comprising a second communication processing unit configured to determine whether to continue the SPS for the terminal apparatus, based on a result of the measurement,

wherein a pattern of frequency hopping for at least one of the one or more different terminal apparatuses is different from the patter of the frequency hopping for the terminal apparatus.

### (Supplementary Note 11)

The first base station according to Supplementary Note 8, wherein the measurement is measurement of a received power from the terminal apparatus in the radio resources.

### (Supplementary Note 12)

The first base station according to Supplementary Note 11 further comprising a second communication processing unit configured to determine whether to change a transmit power or a modulation and coding scheme of the terminal apparatus, based on a result of the measurement.

### (Supplementary Note 13)

The first base station according to Supplementary Note 1 or 2, wherein the terminal apparatus is a terminal apparatus that communicates with the second base station.

### (Supplementary Note 14)

The first base station according to any one of Supplementary Notes 1 to 13, wherein the first communication processing unit transmits, to the second base station, a message including the hopping pattern control information and receives, from the second base station, a response message to the message.

### (Supplementary Note 15)

The first base station according to Supplementary Note 14, wherein the response message indicates acceptance or rejection of the hopping pattern control information.

### (Supplementary Note 16)

The first base station according to any one of Supplementary Notes 1 to 15, wherein the frequency hopping is uplink frequency hopping.

### (Supplementary Note 17)

The first base station according to Supplementary Note 16, wherein the frequency hopping is physical uplink shared channel (PUSCH) frequency hopping.

### (Supplementary Note 18)

The first base station according to any one of Supplementary Notes 1 to 15, wherein the frequency hopping is downlink frequency hopping.

### (Supplementary Note 19)

The first base station according to Supplementary Note 18, wherein the terminal apparatus is a terminal apparatus that employs narrow band Internet of Things (NB-IoT).

### (Supplementary Note 20)

The first base station according to any one of Supplementary Notes 1 to 19, wherein the frequency hopping is intra-subframe frequency hopping.

### (Supplementary Note 21)

The first base station according to any one of Supplementary Notes 1 to 19, wherein the frequency hopping is inter-subframe frequency hopping.

### (Supplementary Note 22)

A second base station comprising:

a first communication processing unit configured to receive, from a first base station, hopping pattern control information related to a pattern of frequency hopping for a terminal apparatus; and

a second communication processing unit configured to communicate with the terminal apparatus based on the hopping pattern control information.

### (Supplementary Note 23)

A terminal apparatus comprising:

a communication processing unit configured to communicate with a first base station or a second base station in accordance with a pattern of frequency hopping for the terminal apparatus,

wherein the first base station is a base station that transmits, to the second base station, hopping pattern control information related to the pattern of the frequency hopping.

### (Supplementary Note 24)

A method in a first base station comprising:

obtaining hopping pattern control information related to a pattern of frequency hopping for a terminal apparatus; and

transmitting the hopping pattern control information to a second base station.

### (Supplementary Note 25)

A program that causes, in a first base station, a processor to execute:

obtaining hopping pattern control information related to a pattern of frequency hopping for a terminal apparatus; and

transmitting the hopping pattern control information to a second base station.

### (Supplementary Note 26)

A non-transitory computer readable recording medium storing a program that causes, in a first base station, a processor to execute:

obtaining hopping pattern control information related to a pattern of frequency hopping for a terminal apparatus; and

transmitting the hopping pattern control information to a second base station.

### (Supplementary Note 27)

A method in a second base station comprising:

receiving, from a first base station, hopping pattern control information related to a pattern of frequency hopping for a terminal apparatus; and

communicating with the terminal apparatus based on the hopping pattern control information.

### (Supplementary Note 28)

A program that causes, in a second base station, a processor to execute:

receiving, from a first base station, hopping pattern control information related to a pattern of frequency hopping for a terminal apparatus; and

communicating with the terminal apparatus based on the hopping pattern control information.

### (Supplementary Note 29)

A non-transitory computer readable recording medium storing a program that causes, in a second base station, a processor to execute:

receiving, from a first base station, hopping pattern control information related to a pattern of frequency hopping for a terminal apparatus; and

communicating with the terminal apparatus based on the hopping pattern control information.

### (Supplementary Note 30)

A method in a terminal apparatus comprising:

communicating with a first base station or a second base station in accordance with a pattern of frequency hopping for the terminal apparatus,

wherein the first base station is a base station that transmits, to the second base station, hopping pattern control information related to the pattern of the frequency hopping.

### (Supplementary Note 31)

A program that causes, in a terminal apparatus, a processor to execute:

communicating with a first base station or a second base station in accordance with a pattern of frequency hopping for the terminal apparatus,

wherein the first base station is a base station that transmits, to the second base station, hopping pattern control information related to the pattern of the frequency hopping.

### (Supplementary Note 32)

A non-transitory computer readable recording medium storing a program that causes, in a terminal apparatus, a processor to execute:

communicating with a first base station or a second base station in accordance with a pattern of frequency hopping for the terminal apparatus,

wherein the first base station is a base station that transmits, to the second base station, hopping pattern control information related to the pattern of the frequency hopping.

This application claims priority based on JP 2018-054651 filed on Mar. 22, 2018, the entire disclosure of which is incorporated herein.

### INDUSTRIAL APPLICABILITY

In a mobile communication system, it is possible to improve communication in a radio access network.

### REFERENCE SIGNS LIST

1, 2, 3 System
100, 200, 300, 600, 700 Base Station
141, 241, 341, 620, 710 First Communication Processing Unit
143, 243, 343, 720 Second Communication Processing Unit
145, 245, 345, 610 Information Obtaining Unit
400, 800 Terminal Apparatus
431, 810 Communication Processing Unit
1000 Base Station
1100 First Unit
1200 Second Unit
1300 Terminal Apparatus

1. A first base station comprising:
a memory storing instructions; and
one or more processors configured to execute the instructions to:
obtain hopping pattern control information related to a pattern of frequency hopping for a terminal apparatus; and
transmit the hopping pattern control information to a second base station.

2. The first base station according to claim 1, wherein the terminal apparatus is a terminal apparatus for which semi-persistent scheduling (SPS) is employed.

3. The first base station according to claim 1, wherein the terminal apparatus is a terminal apparatus that communicates with the first base station.

4. The first base station according to claim 3, wherein
the one or more processors are configured to execute the instructions to:
obtain the hopping pattern control information and subframe information indicating a subframe in which the pattern of the frequency hopping is to be used, and
transmit the hopping pattern control information and the subframe information to the second base station.

5. The first base station according to claim 3 wherein
the one or more processors are configured to execute the instructions to select the pattern of the frequency hopping.

6. The first base station according to claim 5, wherein
the one or more processors are configured to execute the instructions to:
receive, from the second base station, different hopping pattern control information related to a pattern of frequency hopping for a different terminal apparatus that communicates with the second base station, and
select the pattern of the frequency hopping for the terminal apparatus that communicates with the first base station, based on the different hopping pattern control information.

7. The first base station according to claim 1, wherein
the one or more processors are configured to execute the instructions to communicate with the terminal apparatus in accordance with the pattern of the frequency hopping.

8. The first base station according to claim 1, wherein the terminal apparatus is a terminal apparatus for which SPS is employed, and wherein the one or more processors are configured to execute the instructions to
perform measurement in radio resources for the SPS for the terminal apparatus.

9. The first base station according to claim 8, wherein the measurement is measurement of interference from one or more different terminal apparatuses in the radio resources.

10. The first base station according to claim 9, wherein
the one or more processors are configured to execute the instructions to determine whether to continue the SPS for the terminal apparatus, based on a result of the measurement, and
wherein a pattern of frequency hopping for at least one of the one or more different terminal apparatuses is different from the patter of the frequency hopping for the terminal apparatus.

11. The first base station according to claim 8, wherein the measurement is measurement of a received power from the terminal apparatus in the radio resources.

12. The first base station according to claim 11 wherein
the one or more processors are configured to execute the instructions to determine whether to change a transmit power or a modulation and coding scheme of the terminal apparatus, based on a result of the measurement.

13. (canceled)

14. The first base station according to claim 1, wherein
the one or more processors are configured to execute the instructions to transmit, to the second base station, a message including the hopping pattern control information and receives, from the second base station, a response message to the message.

15. The first base station according to claim 14, wherein the response message indicates acceptance or rejection of the hopping pattern control information.

16. The first base station according to claim 1, wherein the frequency hopping is uplink frequency hopping.

17. (canceled)

18. The first base station according to claim 1, wherein the frequency hopping is downlink frequency hopping.

19. (canceled)

20. The first base station according to claim 1, wherein the frequency hopping is intra-subframe frequency hopping.

21. The first base station according to claim 1, wherein the frequency hopping is inter-subframe frequency hopping.

22. A second base station comprising:
a memory storing instructions; and
one or more processors configured to execute the instructions to:
receive, from a first base station, hopping pattern control information related to a pattern of frequency hopping for a terminal apparatus; and
communicate with the terminal apparatus based on the hopping pattern control information.

23. A terminal apparatus comprising:
a memory storing instructions; and
one or more processors configured to execute the instructions to:
communicate with a first base station or a second base station in accordance with a pattern of frequency hopping for the terminal apparatus,
wherein the first base station is a base station that transmits, to the second base station, hopping pattern control information related to the pattern of the frequency hopping.

24-32. (canceled)
